(19) United States
(12) Patent Application Publication
(10) Pub. No.: US 2016/0340564 A1
(43) Pub. Date: Nov. 24, 2016

(54) ABRASIVE PARTICLES AND METHOD OF FORMING SAME

(71) Applicant: SAINT-GOBAIN CERAMICS & PLASTICS, INC., Worcester, MA (US)

(72) Inventors: David F. LOUAPRE, Paris (FR); Eric MOCH, Allston, MA (US)

(21) Appl. No.: 15/160,853

(22) Filed: May 20, 2016

Related U.S. Application Data
(60) Provisional application No. 62/165,028, filed on May 21, 2015.

(51) Int. Cl. C09K 3/14; C04B 35/64; C04B 35/624; C04B 35/63; C01F 7/02; C04B 35/10

(52) U.S. Cl. CPC C09K 3/1418; C01F 7/023; C04B 35/10; C04B 35/624; C04B 35/6303; C04B 35/64; C04B 2235/3217; C04B 2235/3206; C04B 2235/3225; C04B 2235/6021; C04B 2235/66

(57) ABSTRACT

An abrasive particle includes a body having at least one microstructural characteristic including average crystal size of not greater than 6 microns or a hardness of at least 20 GPa, and wherein the body further has at least one deformation characteristic including a primary deformation amplitude of not greater than 30 percent, a primary deformation time of not greater than 280 minutes, or a secondary deformation characteristic rate of not greater than 6×10−3 percent/minute.

### CROSS-REFERENCE TO RELATED APPLICATION(S)

The present application claims priority from U.S. Provisional Patent Application No. 62/165,028, filed May 21, 2015, entitled “ABRASIVE PARTICLES AND METHOD OF FORMING SAME,” naming inventors David F. Louapre and Eric Moch, and said provisional application is incorporated by reference herein in its entirety for all purposes.

### BACKGROUND

1. Field of the Disclosure

The following is directed to shaped abrasive particles, and more particularly, to composite shaped abrasive particles having certain features and methods of forming such composite shaped abrasive particles.

2. Description of the Related Art

Abrasive articles incorporating abrasive particles are useful for various material removal operations including grinding, finishing, polishing, and the like. Depending upon the type of abrasive material, such abrasive particles can be useful in shaping or grinding various materials in the manufacturing of goods. Certain types of abrasive particles have been formulated to date that have particular geometries, such as triangular shaped abrasive particles and abrasive articles incorporating such objects. See, for example, U.S. Pat. Nos. 5,201,916; 5,366,523; and 5,984,988.

Previously, three basic technologies that have been employed to produce abrasive particles having a specified shape, which are fusion, sintering, and chemical ceramic. In the fusion process, abrasive particles can be shaped by a chill roll, the face of which may or may not be engraved, a mold into which molten material is poured, or a heat sink material immersed in an aluminum oxide melt. See, for example, U.S. Pat. No. 3,377,660. In sintering processes, abrasive particles can be formed from refractory powders having a particle size of up to 10 micrometers in diameter. Binders can be added to the powders along with a lubricant and a suitable solvent to form a mixture that can be shaped into platelets or rods of various lengths and diameters. See, for example, U.S. Pat. No. 3,079,242. Chemical ceramic technology involves converting a colloidal dispersion or hydrosol (sometimes called a sol) to a gel or any other physical state that restrains the mobility of the components, drying, and firing to obtain a ceramic material. See, for example, U.S. Pat. Nos. 4,744,802 and 4,848,041. Other relevant disclosures on shaped abrasive particles and associated methods of forming and abrasive articles incorporating such particles are available at: http://www.abel-ip.com/publications/.

The industry continues to demand improved abrasive materials and abrasive articles.

### SUMMARY

According to a first aspect, an abrasive particle includes a body having at least one microstructural characteristic including:
1) an average crystal size of not greater than 6 microns; or
2) a hardness of at least 20 GPa;
and wherein the body further comprises at least one deformation characteristic including:
a primary deformation amplitude of not greater than 30 percent
a primary deformation time of not greater than 280 minutes; or
a secondary deformation characteristic rate of not greater than 6×10⁻³ percent/min.

In yet another aspect, an abrasive particle includes a body having an average crystal size of not greater than 6 microns, a primary deformation amplitude of not greater than 30 percent.

For yet another aspect, an abrasive particle comprises a body having a hardness of at least 20 GPa, a primary deformation amplitude of not greater than 30 percent.

Still, in one aspect, an abrasive particle includes a shaped abrasive particle including a body having a primary deformation amplitude and time multiplier of not greater than 700 percent minutes.

According to another aspect, an abrasive particle comprises a body including a first dopant comprising magnesium and a second dopant comprising at least one element of the group consisting of yttrium, lanthanum, a rare-earth element, wherein the body comprises a greater content of the second dopant compared to a content of the first dopant, and a primary deformation amplitude of not greater than 9 percent.

For another aspect, an abrasive particle comprises a body including a first dopant comprising magnesium and a grain boundary phase comprising at least one of yttrium, lanthanum, and a rare-earth element combined with aluminum and oxygen.

### BRIEF DESCRIPTION OF THE FIGURES

The present disclosure may be better understood, and its numerous features and advantages made apparent to those skilled in the art by referencing the accompanying drawings.

FIG. 1A includes a portion of a system for forming shaped abrasive particle fractions in accordance with an embodiment.

FIG. 1B includes a portion of the system of FIG. 1A according to an embodiment.

FIG. 2 includes a perspective view illustration of a shaped abrasive particle according to an embodiment.

FIG. 3A includes a perspective view illustration of a shaped abrasive particle according to an embodiment.

FIG. 3B includes a perspective view illustration of an elongated abrasive particle according to an embodiment.

FIGS. 4A-4D include top-down illustrations of shaped abrasive particles according to an embodiment.

FIG. 5A includes an illustration of a body of a particulate material having a second phase substantially uniformly dispersed within the body according to an embodiment.

FIG. 5B includes an illustration of a particulate material having a second phase non-uniformly dispersed within the body according to an embodiment.

FIG. 6A includes a schematic of the testing set-up for conducting the standardized creep test.

FIG. 6B includes an illustration of two different testing set-ups for conducting the standardized creep test.

FIG. 6C includes a generalized plot of high temperature creep generated according to the standardized creep test including a primary regime and a secondary regime according to an embodiment.

FIG. 7 includes an illustration of a portion of a coated abrasive according to an embodiment.

FIG. 8 includes an illustration of a portion of a bonded abrasive according to an embodiment.

FIGS. 9A-9C include SEM images of Samples S1-S3 according to an embodiment.

FIG. 10 includes plots of displacement versus time for certain samples and comparative samples according to the high temperature creep test.

FIG. 11 includes an image of a conventional shaped abrasive particle.

FIG. 12 includes a plot of hot hardness versus temperature for certain samples and comparative samples according to the hot hardness test.

### DETAILED DESCRIPTION

The following is directed to abrasive particles, including but not limited to, shaped abrasive particles. The shaped abrasive particles may be utilized in various applications, including for example coated abrasives, bonded abrasives, free abrasives, and a combination thereof. Various other uses may be derived for the shaped abrasive particles.

Various methods may be utilized to obtain shaped abrasive particles. The particles may be obtained from a commercial source or fabricated. Some suitable processes used to fabricate the shaped abrasive particles can include, but is not limited to, depositing, printing (e.g., screen-printing), molding, pressing, casting, sectioning, cutting, dicing, punching, pressing, drying, curing, coating, extruding, rolling, and a combination thereof.

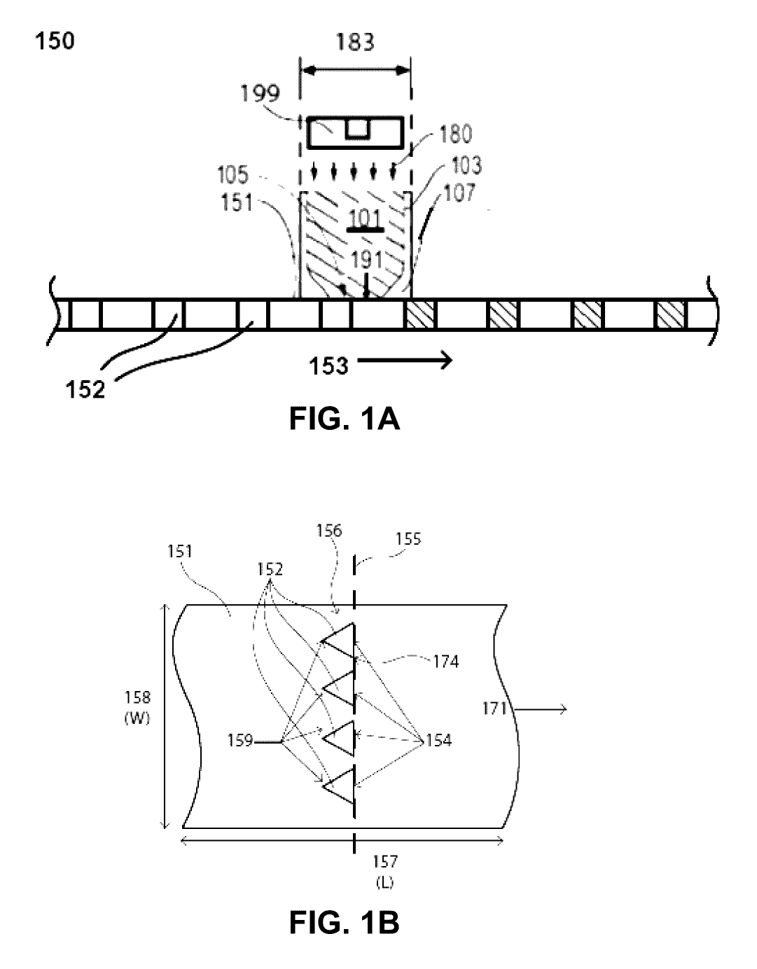

FIG. 1A includes an illustration of a system 150 for forming a shaped abrasive particle in accordance with one, non-limiting embodiment. The process of forming shaped abrasive particles can be initiated by forming a mixture 101 including a ceramic material and a liquid. In particular, the mixture 101 can be a gel formed of a ceramic powder material and a liquid. In accordance with an embodiment, the gel can be formed of the ceramic powder material as an integrated network of discrete particles. The mixture 101 may also include one or more dopant materials or precursor dopant materials as described in embodiments herein. The precursor dopant material may change composition during processing to form a dopant material within the finally formed abrasive particle.

The mixture 101 may contain a certain content of solid material, liquid material, and additives such that it has suitable rheological characteristics for manipulation according to the desired shaping process. The mixture can have suitable rheological characteristics that form a dimensionally stable phase of material that can be formed through the shaping process. A dimensionally stable phase of material is a material that can be formed to have a particular shape and substantially maintain the shape for at least a portion of the processing subsequent to forming. In certain instances, the shape may be retained throughout subsequent processing, such that the shape initially provided in the forming process is present in the finally-formed object. In some instances, the mixture 101 may not be a shape-stable material during and after the forming process, and the process may rely upon solidification and stabilization of the mixture 101 by further processing, such as drying.

The mixture 101 can be formed to have a particular content of solid material, such as the ceramic powder material. For example, in one embodiment, the mixture 101 can have a solids content of at least about 25 wt %, such as at least about 35 wt %, or even at least about 38 wt % for the total weight of the mixture 101. Still, in at least one non-limiting embodiment, the solids content of the mixture 101 can be not greater than about 75 wt %, such as not greater than about 70 wt %, not greater than about 65 wt %, not greater than about 55 wt %, not greater than about 45 wt %, or not greater than about 42 wt %. It will be appreciated that the content of the solids materials in the mixture 101 can be within a range between any of the minimum and maximum percentages noted above.

According to one embodiment, the ceramic powder material can include an oxide, a nitride, a carbide, a boride, an oxycarbide, an oxynitride, and a combination thereof. In particular instances, the ceramic material can include alumina. More specifically, the ceramic material may include a boehmite material, which may be a precursor of alpha alumina. The term “boehmite” is generally used herein to denote alumina hydrates including mineral boehmite, typically being Al₂O₃.H₂O and having a water content on the order of 15%, as well as pseudoboehmite, having a water content higher than 15%, such as 20-38% by weight. It is noted that boehmite (including pseudoboehmite) has a particular and identifiable crystal structure, and therefore a unique X-ray diffraction pattern. As such, boehmite is distinguished from other aluminous materials including other hydrated aluminas such as ATH (aluminum trihydroxide), a common precursor material used herein for the fabrication of boehmite particulate materials.

Furthermore, the mixture 101 can be formed to have a particular content of liquid material. Some suitable liquids may include water. In accordance with one embodiment, the mixture 101 can be formed to have a liquid content less than the solids content of the mixture 101. In more particular instances, the mixture 101 can have a liquid content of at least about 25 wt % for the total weight of the mixture 101. In other instances, the amount of liquid within the mixture 101 can be greater, such as at least about 35 wt %, at least about 45 wt %, at least about 50 wt %, or even at least about 58 wt %. Still, in at least one non-limiting embodiment, the liquid content of the mixture can be not greater than about 75 wt %, such as not greater than about 70 wt %, not greater than about 65 wt %, not greater than about 62 wt %, or even not greater than about 60 wt %. It will be appreciated that the content of the liquid in the mixture 101 can be within a range between any of the minimum and maximum percentages noted above.

Furthermore, to facilitate processing and forming shaped abrasive particles according to embodiments herein, the mixture 101 can have a particular storage modulus. For example, the mixture 101 can have a storage modulus of at least about 1×10⁴ Pa, such as at least about 4×10⁴ Pa, or even at least about 5×10⁴ Pa. However, in at least one non-limiting embodiment, the mixture 101 may have a storage modulus of not greater than about 1×10⁷ Pa, such as not greater than about 2×10⁶ Pa. It will be appreciated that the storage modulus of the mixture 101 can be within a range between any of the minimum and maximum values noted above.

The storage modulus can be measured via a parallel plate system using ARES or AR-G2 rotational rheometers, with Peltier plate temperature control systems. For testing, the mixture 101 can be extruded within a gap between two plates that are set to be approximately 8 mm apart from each other. After extruding the gel into the gap, the distance between the two plates defining the gap is reduced to 2 mm until the mixture 101 completely fills the gap between the plates. After wiping away excess mixture, the gap is decreased by 0.1 mm and the test is initiated. The test is an oscillation strain sweep test conducted with instrument settings of a strain range between 0.01% to 100%, at 6.28 rad/s (1 Hz), using 25-mm parallel plate and recording 10 points per decade. Within 1 hour after the test completes, the gap is lowered again by 0.1 mm and the test is repeated. The test can be repeated at least 6 times. The first test may differ from the second and third tests. Only the results from the second and third tests for each specimen should be reported.

Furthermore, to facilitate processing and forming shaped abrasive particles according to embodiments herein, the mixture 101 can have a particular viscosity. For example, the mixture 101 can have a viscosity of at least about 2×10³ Pa s, such as at least about 3×10³ Pa s, at least about 4×10³ Pa s, at least about 5×10³ Pa s, at least about 6×10³ Pa s, at least about 8×10³ Pa s, at least about 10×10³ Pa s, at least about 20×10³ Pa s, at least about 30×10³ Pa s, at least about 40×10³ Pa s, at least about 50×10³ Pa s, at least about 60×10³ Pa s, or at least about 65×10³ Pa s. In at least one non-limiting embodiment, the mixture 101 may have a viscosity of not greater than about 100×10³ Pa s, such as not greater than about 95×10³ Pa s, not greater than about 90×10³ Pa s, or even not greater than about 85×10³ Pa s. It will be appreciated that the viscosity of the mixture 101 can be within a range between any of the minimum and maximum values noted above. The viscosity can be measured in the same manner as the storage modulus as described above.

Moreover, the mixture 101 can be formed to have a particular content of organic materials including, for example, organic additives that can be distinct from the liquid to facilitate processing and formation of shaped abrasive particles according to the embodiments herein. Some suitable organic additives can include stabilizers, binders such as fructose, sucrose, lactose, glucose, UV curable resins, and the like.

Notably, the embodiments herein may utilize a mixture 101 that can be distinct from slurries used in conventional forming operations. For example, the content of organic materials within the mixture 101 and, in particular, any of the organic additives noted above, may be a minor amount as compared to other components within the mixture 101. In at least one embodiment, the mixture 101 can be formed to have not greater than about 30 wt % organic material for the total weight of the mixture 101. In other instances, the amount of organic materials may be less, such as not greater than about 15 wt %, not greater than about 10 wt %, or even not greater than about 5 wt %. Still, in at least one non-limiting embodiment, the amount of organic materials within the mixture 101 can be at least about 0.01 wt %, such as at least about 0.5 wt % for the total weight of the mixture 101. It will be appreciated that the amount of organic materials in the mixture 101 can be within a range between any of the minimum and maximum values noted above.

Moreover, the mixture 101 can be formed to have a particular content of acid or base, distinct from the liquid content, to facilitate processing and formation of shaped abrasive particles according to the embodiments herein. Some suitable acids or bases can include nitric acid, sulfuric acid, citric acid, chloric acid, tartaric acid, phosphoric acid, ammonium nitrate, and ammonium citrate. According to one particular embodiment in which a nitric acid additive is used, the mixture 101 can have a pH of less than about 5, and more particularly, can have a pH within a range between about 2 and about 4.

The system 150 of FIG. 1A, can include a die 103. As illustrated, the mixture 101 can be provided within the interior of the die 103 and configured to be extruded through a die opening 105 positioned at one end of the die 103. As further illustrated, extruding can include applying a force 180 on the mixture 101 to facilitate extruding the mixture 101 through the die opening 105. During extrusion within an application zone 183, a tool 151 can be in direct contact with a portion of the die 103 and facilitate extrusion of the mixture 101 into the tool cavities 152. The tool 151 can be in the form of a screen, such as illustrated in FIG. 1A, wherein the cavities 152 extend through the entire thickness of the tool 151. Still, it will be appreciated that the tool 151 may be formed such that the cavities 152 extend for a portion of the entire thickness of the tool 151 and have a bottom surface, such that the volume of space configured to hold and shape the mixture 101 is defined by a bottom surface and side surfaces.

The tool 151 may be formed of a metal material, including for example, a metal alloy, such as stainless steel. In other instances, the tool 151 may be formed of an organic material, such as a polymer.

In accordance with an embodiment, a particular pressure may be utilized during extrusion. For example, the pressure can be at least about 10 kPa, such as at least about 500 kPa. Still, in at least one non-limiting embodiment, the pressure utilized during extrusion can be not greater than about 4 MPa. It will be appreciated that the pressure used to extrude the mixture 101 can be within a range between any of the minimum and maximum values noted above. In particular instances, the consistency of the pressure delivered by a piston 199 may facilitate improved processing and formation of shaped abrasive particles. Notably, controlled delivery of consistent pressure across the mixture 101 and across the width of the die 103 can facilitate improved processing control and improved dimensional characteristics of the shaped abrasive particles.

Prior to depositing the mixture 101 in the tool cavities 152, a mold release agent can be applied to the surfaces of the tool cavities 152, which may facilitate removal of precursor shaped abrasive particles from the tool cavities 152 after further processing. Such a process can be optional and may not necessarily be used to conduct the molding process. A suitable exemplary mold release agent can include an organic material, such as one or more polymers (e.g., PTFE). In other instances, an oil (synthetic or organic) may be applied as a mold release agent to the surfaces of the tool cavities 152. A suitable oil may be peanut oil. The mold release agent may be applied using any suitable manner, including but not limited to, depositing, spraying, printing, brushing, coating, and the like.

The mixture 101 may be deposited within the tool cavities 152, which may be shaped in any suitable manner to form shaped abrasive particles having shapes corresponding to the shape of the tool cavities 152.

Referring briefly to FIG. 1B, a portion of the tool 151 is illustrated. As shown, the tool 151 can include the tool cavities 152, and more particularly, a plurality of tool cavities 152 extending into the volume of the tool 151. In accordance with an embodiment, the tool cavities 152 can have a two-dimensional shape as viewed in a plane defined by the length (1) and width (w) of the tool 151. The two-dimensional shape can include various shapes such as, for example, polygons, ellipsoids, numerals, Greek alphabet letters, Latin alphabet letters, Russian alphabet characters, complex shapes including a combination of polygonal shapes, and a combination thereof. In particular instances, the tool cavities 152 may have two-dimensional polygonal shapes such as a rectangle, a quadrilateral, a pentagon, a hexagon, a heptagon, an octagon, a nonagon, a decagon, and a combination thereof. Notably, as will be appreciated in further reference to the shaped abrasive particles of the embodiments herein, the tool cavities 152 may utilize various other shapes.

While the tool 151 of FIG. 1B is illustrated as having tool cavities 152 oriented in a particular manner relative to each other, it will be appreciated that various other orientations may be utilized. In accordance with one embodiment, each of the tool cavities 152 can have substantially the same orientation relative to each other, and substantially the same orientation relative to the surface of the screen. For example, each of the tool cavities 152 can have a first edge 154 defining a first plane 155 for a first row 156 of the tool cavities 152 extending laterally across a lateral axis 158 of the tool 151. The first plane 155 can extend in a direction substantially orthogonal to a longitudinal axis 157 of the tool 151. However, it will be appreciated, that in other instances, the tool cavities 152 need not necessarily have the same orientation relative to each other.

Moreover, the first row 156 of tool cavities 152 can be oriented relative to a direction of translation to facilitate particular processing and controlled formation of shaped abrasive particles. For example, the tool cavities 152 can be arranged on the tool 151 such that the first plane 155 of the first row 156 defines an angle relative to the direction of translation 171. As illustrated, the first plane 155 can define an angle that is substantially orthogonal to the direction of translation 171. Still, it will be appreciated that in one embodiment, the tool cavities 152 can be arranged on the tool 151 such that the first plane 155 of the first row 156 defines a different angle with respect to the direction of translation, including for example, an acute angle or an obtuse angle. Still, it will be appreciated that the tool cavities 152 may not necessarily be arranged in rows. The tool cavities 152 may be arranged in various particular ordered distributions with respect to each other on the tool 151, such as in the form of a two-dimensional pattern. Alternatively, the openings may be disposed in a random manner on the tool 151.

Referring again to FIG. 1A, during operation of the system 150, the tool 151 can be translated in a direction 153 to facilitate a continuous molding operation. As will be appreciated, the tool 151 may be in the form of a continuous belt, which can be translated over rollers to facilitate continuous processing. In some embodiments, the tool 151 can be translated while extruding the mixture 101 through the die opening 105. As illustrated in the system 150, the mixture 101 may be extruded in a direction 191. The direction of translation 153 of the tool 151 can be angled relative to the direction of extrusion 191 of the mixture 101. While the angle between the direction of translation 153 and the direction of extrusion 191 is illustrated as substantially orthogonal in the system 100, other angles are contemplated, including for example, an acute angle or an obtuse angle. After the mixture 101 is extruded through the die opening 105, the mixture 101 and tool 151 may be translated under a knife edge 107 attached to a surface of the die 103. The knife edge 107 may define a region at the front of the die 103 that facilitates displacement of the mixture 101 into the tool cavities 152 of the tool 151.

In the molding process, the mixture 101 may undergo significant drying while contained in the tool cavity 152. Therefore, shaping may be primarily attributed to substantial drying and solidification of the mixture 101 in the tool cavities 152 to shape the mixture 101. In certain instances, the shaped abrasive particles formed according to the molding process may exhibit shapes more closely replicating the features of the mold cavity compared to other processes, including for example, screen printing processes. However, it should be noted that certain beneficial shape characteristics may be more readily achieved through screen printing processes.

After applying the mold release agent, the mixture 101 can be deposited within the mold cavities and dried. Drying may include removal of a particular content of certain materials from the mixture 101, including volatiles, such as water or organic materials. In accordance with an embodiment, the drying process can be conducted at a drying temperature of not greater than about 300° C., such as not greater than about 250° C., not greater than about 200° C., not greater than about 150° C., not greater than about 100° C., not greater than about 80° C., not greater than about 60° C., not greater than about 40° C., or even not greater than about 30° C. Still, in one non-limiting embodiment, the drying process may be conducted at a drying temperature of at least about −20° C., such as at least about −10° C. at least about 0° C. at least about 5° C. at least about 10° C., or even at least about 20° C. It will be appreciated that the drying temperature may be within a range between any of the minimum and maximum temperatures noted above.

In certain instances, drying may be conducted for a particular duration to facilitate the formation of shaped abrasive particles according to embodiments herein. For example, drying can be conducted for a duration of at least about 1 minute, such as at least about 2 minutes, at least about 4 minutes, at least about 6 minutes, at least about 8 minutes, at least about 10 minutes, such as at least about 30 minutes, at least about 1 hour, at least about 2 hours, at least about 4 hours, at least about 8 hours, at least about 12 hours, at least about 15 hours, at least about 18 hours, at least about 24 hours. In still other instances, the process of drying may be not greater than about 30 hours, such as not greater than about 24 hours, not greater than about 20 hours, not greater than about 15 hours, not greater than about 12 hours, not greater than about 10 hours, not greater than about 8 hours, not greater than about 6 hours, not greater than about 4 hours. It will be appreciated that the duration of drying can be within a range between any of the minimum and maximum values noted above.

Additionally, drying may be conducted at a particular relative humidity to facilitate formation of shaped abrasive particles according to the embodiments herein. For example, drying may be conducted at a relative humidity of at least about 20%, at least about 30%, at least about 40%, at least about 50%, at least about 60%, such as at least about 62%, at least about 64%, at least about 66%, at least about 68%, at least about 70%, at least about 72%, at least about 74%, at least about 76%, at least about 78%, or even at least about 80%. In still other non-limiting embodiments, drying may be conducted at a relative humidity of not greater than about 90%, such as not greater than about 88%, not greater than about 86%, not greater than about 84%, not greater than about 82%, not greater than about 80%, not greater than about 78%, not greater than about 76%, not greater than about 74%, not greater than about 72%, not greater than about 70%, not greater than about 65%, not greater than about 60%, not greater than about 55%, not greater than about 50%, not greater than about 45%, not greater than about 40%, not greater than about 35%, not greater than about 30%, or even not greater than about 25%. It will be appreciated that the relative humidity utilized during drying can be within a range between any of the minimum and maximum percentages noted above.

After completing the drying process, the mixture 101 can be released from the tool cavities 152 to produce precursor shaped abrasive particles. Notably, before the mixture 101 is removed from the tool cavities 152 or after the mixture 101 is removed and the precursor shaped abrasive particles are formed, one or more post-forming processes may be completed. Such processes can include surface shaping, curing, reacting, radiating, planarizing, calcining, sintering, sieving, doping, and a combination thereof. For example, in one optional process, the mixture 101 or precursor shaped abrasive particles may be translated through an optional shaping zone, wherein at least one exterior surface of the mixture or precursor shaped abrasive particles may be shaped. In still another embodiment, the mixture 101 as contained in the mold cavities or the precursor shaped abrasive particles may be translated through an optional application zone, wherein a dopant material can be applied. In particular instances, the process of applying a dopant material can include selective placement of the dopant material on at least one exterior surface of the mixture 101 or precursor shaped abrasive particles.

The dopant material may be applied utilizing various methods including for example, spraying, dipping, depositing, impregnating, transferring, punching, cutting, pressing, crushing, and any combination thereof. In accordance with an embodiment, applying a dopant material can include the application of a particular material, such as a precursor. In certain instances, the precursor can be a salt, such as a metal salt, that includes a dopant material to be incorporated into the finally-formed shaped abrasive particles. For example, the metal salt can include an element or compound that is the precursor to the dopant material. It will be appreciated that the salt material may be in liquid form, such as in a dispersion comprising the salt and liquid carrier. The salt may include nitrogen, and more particularly, can include a nitrate. In other embodiments, the salt can be a chloride, sulfate, phosphate, and a combination thereof. In one embodiment, the salt can include a metal nitrate, and more particularly, consist essentially of a metal nitrate. Suitable dopant materials are described in more detail herein.

The forming process may further include a sintering process. For certain embodiments herein, sintering can be conducted after removing the mixture from the tool cavities 152 and forming the precursor shaped abrasive particles. Sintering of the precursor shaped abrasive particles 123 may be utilized to densify the particles, which are generally in a green state. In a particular instance, the sintering process can facilitate the formation of a high-temperature phase of the ceramic material. For example, in one embodiment, the precursor shaped abrasive particles may be sintered such that a high-temperature phase of alumina, such as alpha alumina, is formed. In one instance, a shaped abrasive particle can comprise at least about 90 wt % alpha alumina for the total weight of the particle. In other instances, the content of alpha alumina may be greater such that the shaped abrasive particle may consist essentially of alpha alumina.

The abrasive particles of the embodiments herein can include particular types of abrasive particle. For example, the abrasive particles may include shaped abrasive particles and/or non-shaped abrasive particles. Various methods may be utilized to obtain shaped abrasive particles as described herein. Non-shaped abrasive particles may be formed through crushing and sieving techniques.

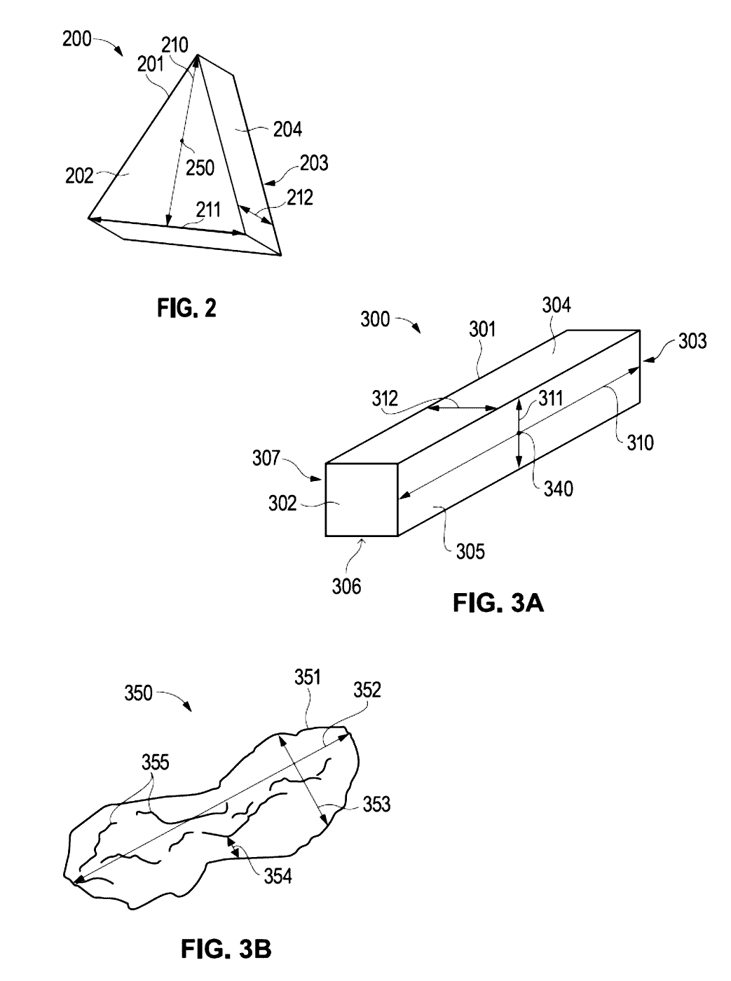

FIG. 2 includes a perspective view illustration of a shaped abrasive particle in accordance with an embodiment. The shaped abrasive particle 200 can include a body 201 including a major surface 202, a major surface 203, and a side surface 204 extending between the major surfaces 202 and 203. As illustrated in FIG. 2, the body 201 of the shaped abrasive particle 200 is a thin-shaped body, wherein the major surfaces 202 and 203 are larger than the side surface 204. Moreover, the body 201 can include a longitudinal axis 210 extending from a point to a base and through the midpoint 250 on the major surface 202. The longitudinal axis 210 can define the longest dimension of the major surface extending through the midpoint 250 of the major surface 202. The body 201 can further include a lateral axis 211 defining a width of the body 201 extending generally perpendicular to the longitudinal axis 210 on the same major surface 202. Finally, as illustrated, the body 201 can include a vertical axis 212, which in the context of thin shaped bodies can define a height (or thickness) of the body 201. For thin-shaped bodies, the length of the longitudinal axis 210 is equal to or greater than the vertical axis 212. As illustrated, the thickness 212 can extend along the side surface 204 between the major surfaces 202 and 203 and perpendicular to the plane defined by the longitudinal axis 210 and lateral axis 211. It will be appreciated that reference herein to length, width, and height of the abrasive particles may be reference to average values taken from a suitable sampling size of abrasive particles of a larger group, including for example, a group of abrasive particle affixed to a fixed abrasive.

The shaped abrasive particles of the embodiments herein, including thin shaped abrasive particles can have a primary aspect ratio of length:width such that the length can be greater than or equal to the width. Furthermore, the length of the body 201 can be greater than or equal to the height. Finally, the width of the body 201 can be greater than or equal to the height. In accordance with an embodiment, the primary aspect ratio of length:width can be at least 1:1, such as at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 201 of the shaped abrasive particle can have a primary aspect ratio of length:width of not greater than 100:1, not greater than 50:1, not greater than 10:1, not greater than 6:1, not greater than 5:1, not greater than 4:1, not greater than 3:1, not greater than 2:1, or even not greater than 1:1. It will be appreciated that the primary aspect ratio of the body 201 can be with a range including any of the minimum and maximum ratios noted above.

Furthermore, the body 201 can have a secondary aspect ratio of width:height that can be at least 1:1, such as at least 1.1:1, at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 201 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be with a range including any of the minimum and maximum ratios of above.

In another embodiment, the body 201 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 201 can be not greater than 100:1, such as not greater than 50:1, not greater than 10:1, not greater than 8:1, not greater than 6:1, not greater than 5:1, not greater than 4:1, not greater than 3:1. It will be appreciated that the tertiary aspect ratio the body 201 can be with a range including any of the minimum and maximum ratios and above.

The abrasive particles of the embodiments herein, including the shaped abrasive particles can include a crystalline material, and more particularly, a polycrystalline material. Notably, the polycrystalline material can include abrasive grains. In one embodiment, the body of the abrasive particle, including for example, the body of a shaped abrasive particle can be essentially free of an organic material, such as, a binder. In at least one embodiment, the abrasive particles can consist essentially of a polycrystalline material.

It may be possible to form the abrasive particles of materials including nitrides, oxides, carbides, borides, oxynitrides, oxyborides, diamond, carbon-containing materials, and a combination thereof. In particular instances, the abrasive particles can include an oxide compound or complex, such as aluminum oxide, zirconium oxide, titanium oxide, yttrium oxide, chromium oxide, strontium oxide, silicon oxide, magnesium oxide, rare-earth oxides, and a combination thereof.

In one particular embodiment, the abrasive particles can include a majority content of alumina. For at least one embodiment, the abrasive particle can include at least 80 wt % alumina, such as at least 90 wt % alumina, at least 91 wt % alumina, at least 92 wt % alumina, at least 93 wt % alumina, at least 94 wt % alumina, at least 95 wt % alumina, at least 96 wt % alumina, or even at least 97 wt % alumina. Still, in at least one particular embodiment, the abrasive particle can include not greater than 99.5 wt % alumina, such as not greater than 99 wt % alumina, not greater than 98.5 wt % alumina, not greater than 97.5 wt % alumina, not greater than 97 wt % alumina not greater than 96 wt % alumina, or even not greater than 94 wt % alumina. It will be appreciated that the abrasive particles of the embodiments herein can include a content of alumina within a range including any of the minimum and maximum percentages noted above. Moreover, in particular instances, the shaped abrasive particles can be formed from a seeded sol-gel. In at least one embodiment, the abrasive particles can consist essentially of alumina and certain dopant materials as described herein.

The abrasive particles of the embodiments herein can include particularly dense bodies, which may be suitable for use as abrasives. For example, the abrasive particles may have a body having a density of at least 95% theoretical density, such as at least 96% theoretical density, at least 97% theoretical density, at least 98% theoretical density or even at least 99% theoretical density.

The abrasive grains (i.e., crystallites) contained within the body of the abrasive particles may have an average grain size (i.e., average crystal size) that is generally not greater than about 100 microns. In other embodiments, the average grain size can be less, such as not greater than about 80 microns or not greater than about 50 microns or not greater than about 30 microns or not greater than about 20 microns or not greater than about 10 microns or not greater than 6 microns or not greater than 5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.6 microns or not greater than 0.5 microns or not greater than 0.4 microns or not greater than 0.3 microns or even not greater than 0.2 microns. Still, the average grain size of the abrasive grains contained within the body of the abrasive particle can be at least about 0.01 microns, such as at least about 0.05 microns or at least about 0.06 microns or at least about 0.07 microns or at least about 0.08 microns or at least about 0.09 microns or at least about 0.1 microns or at least about 0.12 microns or at least about 0.15 microns or at least about 0.17 microns or at least about 0.2 microns or even at least about 0.3 microns. It will be appreciated that the abrasive particles can have an average grain size (i.e., average crystal size) within a range between any of the minimum and maximum values noted above.

The average grain size (i.e., average crystal size) can be measured based on the uncorrected intercept method using scanning electron microscope (SEM) photomicrographs. Samples of abrasive grains are prepared by making a bakelite mount in epoxy resin then polished with diamond polishing slurry using a Struers Tegramin 30 polishing unit. After polishing the epoxy is heated on a hot plate, the polished surface is then thermally etched for 5 minutes at 150° C. below sintering temperature. Individual grains (5-10 grits) are mounted on the SEM mount then gold coated for SEM preparation. SEM photomicrographs of three individual abrasive particles are taken at approximately 50,000× magnification, then the uncorrected crystallite size is calculated using the following steps: 1) draw diagonal lines from one corner to the opposite corner of the crystal structure view, excluding black data band at bottom of photo 2) measure the length of the diagonal lines as L1 and L2 to the nearest 0.1 centimeters; 3) count the number of grain boundaries intersected by each of the diagonal lines, (i.e., grain boundary intersections I1 and I2) and record this number for each of the diagonal lines, 4) determine a calculated bar number by measuring the length (in centimeters) of the micron bar (i.e., “bar length”) at the bottom of each photomicrograph or view screen, and divide the bar length (in microns) by the bar length (in centimeters); 5) add the total centimeters of the diagonal lines drawn on photomicrograph (L1+L2) to obtain a sum of the diagonal lengths; 6) add the numbers of grain boundary intersections for both diagonal lines (I1+I2) to obtain a sum of the grain boundary intersections; 7) divide the sum of the diagonal lengths (L1+L2) in centimeters by the sum of grain boundary intersections (I1+I2) and multiply this number by the calculated bar number. This process is completed at least three different times for three different, randomly selected samples to obtain an average crystallite size.

In accordance with certain embodiments, certain abrasive particles can be composite articles including at least two different types of grains within the body of the abrasive particle. It will be appreciated that different types of grains are grains having different compositions with regard to each other. For example, the body of the abrasive particle can be formed such that is includes at least two different types of grains, wherein the two different types of grains can be nitrides, oxides, carbides, borides, oxynitrides, oxyborides, diamond, and a combination thereof.

In accordance with an embodiment, the abrasive particles can have an average particle size, as measured by the largest dimension (i.e., length) of at least about 100 microns. In fact, the abrasive particles can have an average particle size of at least about 150 microns, such as at least about 200 microns, at least about 300 microns, at least about 400 microns, at least about 500 microns, at least about 600 microns, at least about microns, at least about 800 microns, or even at least about 900 microns. Still, the abrasive particles of the embodiments herein can have an average particle size that is not greater than about 5 mm, such as not greater than about 3 mm, not greater than about 2 mm, or even not greater than about 1.5 mm. It will be appreciated that the abrasive particles can have an average particle size within a range between any of the minimum and maximum values noted above.

FIG. 2 includes an illustration of a shaped abrasive particle having a two-dimensional shape as defined by the plane of the upper major surface 202 or major surface 203, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, shapes including a central region and a plurality of arms (e.g., at least three arms) extending from a central region (e.g., star shapes), and a combination thereof. Particular polygonal shapes include rectangular, trapezoidal, quadrilateral, pentagonal, hexagonal, heptagonal, octagonal, nonagonal, decagonal, and any combination thereof. In another instance, the finally-formed shaped abrasive particles can have a body having a two-dimensional shape such as an irregular quadrilateral, an irregular rectangle, an irregular trapezoid, an irregular pentagon, an irregular hexagon, an irregular heptagon, an irregular octagon, an irregular nonagon, an irregular decagon, and a combination thereof. An irregular polygonal shape is one where at least one of the sides defining the polygonal shape is different in dimension (e.g., length) with respect to another side. As illustrated in other embodiments herein, the two-dimensional shape of certain shaped abrasive particles can have a particular number of exterior points or external corners. For example, the body of the shaped abrasive particles can have a two-dimensional polygonal shape as viewed in a plane defined by a length and width, wherein the body comprises a two-dimensional shape having at least 4 exterior points (e.g., a quadrilateral), at least 5 exterior points (e.g., a pentagon), at least 6 exterior points (e.g., a hexagon), at least 7 exterior points (e.g., a heptagon), at least 8 exterior points (e.g., an octagon), at least 9 exterior points (e.g., a nonagon), and the like.

The elongated abrasive particle 350 can have certain attributes of the other abrasive particles described in the embodiments herein, including for example but not limited to, composition, microstructural features (e.g., average grain size), hardness, porosity, and the like.

FIG. 3A includes a perspective view illustration of a shaped abrasive particle according to another embodiment. Notably, the shaped abrasive particle 300 can include a body 301 including a surface 302 and a surface 303, which may be referred to as end surfaces 302 and 303. The body can further include surfaces 304, 305, 306, 307 extending between and coupled to the end surfaces 302 and 303. The shaped abrasive particle of FIG. 3A is an elongated shaped abrasive particle having a longitudinal axis 310 that extends along the surface 305 and through the midpoint 340 between the end surfaces 302 and 303. It will be appreciated that the surface 305 is selected for illustrating the longitudinal axis 310, because the body 301 has a generally square cross-sectional contour as defined by the end surfaces 302 and 303. As such, the surfaces 304, 305, 306, and 307 have approximately the same size relative to each other. However in the context of other elongated abrasive particles, wherein the surfaces 302 and 303 define a different shape, for example, a rectangular shape, wherein one of the surfaces 304, 305, 306, and 307 may be larger relative to the others, the largest surface of those surfaces defines the major surface and therefore the longitudinal axis would extend along the largest of those surfaces. As further illustrated, the body 301 can include a lateral axis 311 extending perpendicular to the longitudinal axis 310 within the same plane defined by the surface 305. As further illustrated, the body 301 can further include a vertical axis 312 defining a height of the abrasive particle, were in the vertical axis 312 extends in a direction perpendicular to the plane defined by the longitudinal axis 310 and lateral axis 311 of the surface 305.

It will be appreciated that like the thin shaped abrasive particle of FIG. 2, the elongated shaped abrasive particle of FIG. 3A can have various two-dimensional shapes, such as those defined with respect to the shaped abrasive particle of FIG. 2. The two-dimensional shape of the body 301 can be defined by the shape of the perimeter of the end surfaces 302 and 303. The elongated shaped abrasive particle 300 can have any of the attributes of the shaped abrasive particles of the embodiments herein.

FIG. 3B includes an illustration of a non-shaped abrasive particle, which may be an elongated, non-shaped abrasive particle. It will be appreciated that the non-shaped abrasive particles of the embodiments herein may not necessarily be elongated, and may be more equiaxed. Shaped abrasive particles may be formed through particular processes, including molding, printing, casting, extrusion, and the like. Shaped abrasive particles are formed such that the each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a high shaped fidelity and consistency in the arrangement of the surfaces and edges relative to each other. By contrast, non-shaped abrasive particles can be formed through different process and have different shape attributes. For example, crushed grains are typically formed by a comminution process wherein a mass of material is formed and then crushed and sieved to obtain abrasive particles of a certain size. However, a non-shaped abrasive particle will have a generally random arrangement of the surfaces and edges, and generally will lack any recognizable two-dimensional or three dimensional shape in the arrangement of the surfaces and edges. Moreover, the non-shaped abrasive particles do not necessarily have a consistent shape with respect to each other and therefore have a significantly lower shape fidelity compared to shaped abrasive particles. The non-shaped abrasive particles generally are defined by a random arrangement of surfaces and edges with respect to each other.

As further illustrated in FIG. 3B, the abrasive article can be a non-shaped abrasive particle having a body 351 and a longitudinal axis 352 defining the longest dimension of the particle, a lateral axis 353 extending perpendicular to the longitudinal axis 352 and defining a width of the particle. Furthermore, the abrasive particle may have a height (or thickness) as defined by the vertical axis 354 which can extend generally perpendicular to a plane defined by the combination of the longitudinal axis 352 and lateral axis 353. As further illustrated, the body 351 of the non-shaped abrasive particle can have a generally random arrangement of edges 355 extending along the exterior surface of the body 351.

As will be appreciated, the abrasive particle can have a length defined by longitudinal axis 352, a width defined by the lateral axis 353, and a vertical axis 354 defining a height. As will be appreciated, the body 351 can have a primary aspect ratio of length:width such that the length is equal to or greater than the width. Furthermore, the length of the body 351 can be equal to or greater than or equal to the height. Finally, the width of the body 351 can be greater than or equal to the height 354. In accordance with an embodiment, the primary aspect ratio of length:width can be at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 351 of the elongated shaped abrasive particle can have a primary aspect ratio of length:width of not greater than 100:1, not greater than 50:1, not greater than 10:1, not greater than 6:1, not greater than 5:1, not greater than 4:1, not greater than 3:1, or even not greater than 2:1. It will be appreciated that the primary aspect ratio of the body 351 can be with a range including any of the minimum and maximum ratios noted above.

Furthermore, the body 351 of the elongated abrasive particle 350 can include a secondary aspect ratio of width:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 351 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be with a range including any of the minimum and maximum ratios of above.

In another embodiment, the body 351 of the elongated abrasive particle 350 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 351 can be not greater than 100:1, such as not greater than 50:1, not greater than 10:1, not greater than 8:1, not greater than 6:1, not greater than 5:1, not greater than 4:1, not greater than 3:1, It will be appreciated that the tertiary aspect ratio the body 351 can be with a range including any of the minimum and maximum ratios and above.

The elongated abrasive particle 350 can have certain attributes of the other abrasive particles described in the embodiments herein, including for example but not limited to, composition, microstructural features (e.g., average grain size), hardness, porosity, and the like.

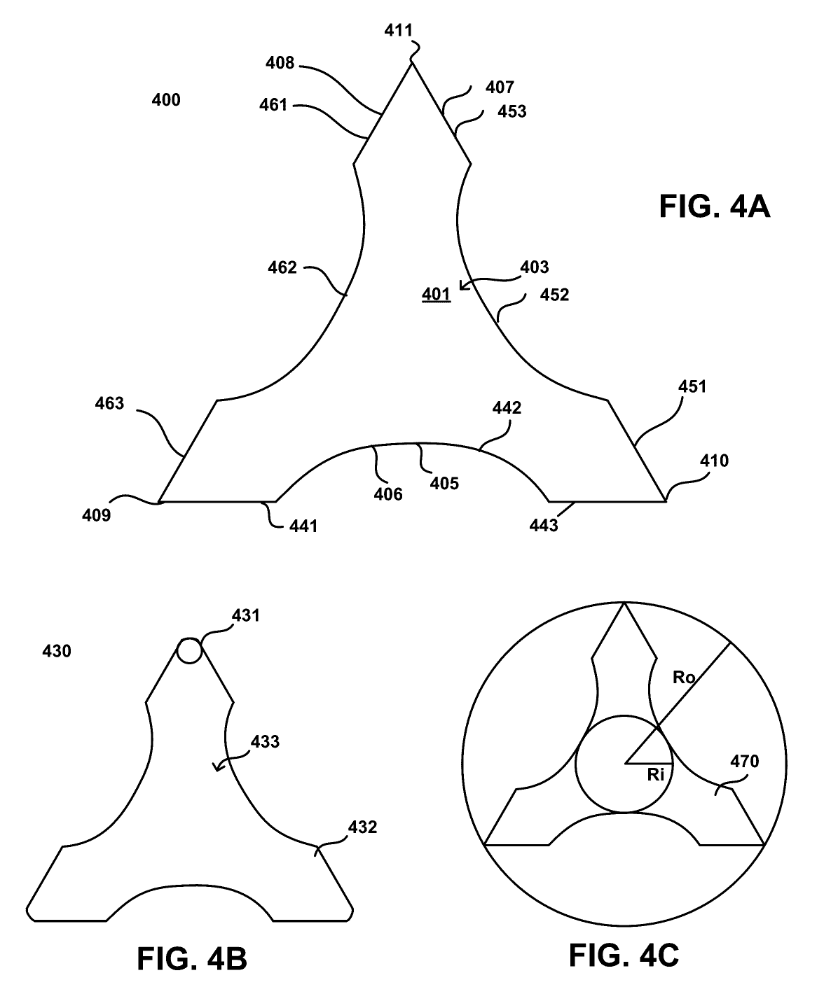

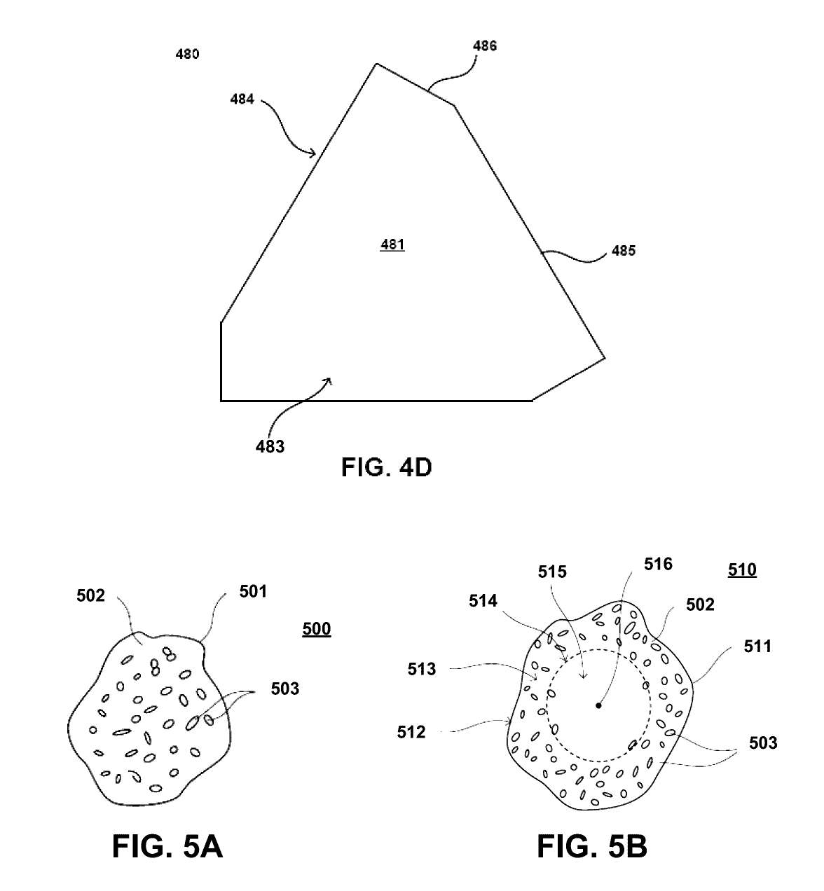

FIG. 4A includes a top view illustration of a shaped abrasive particle according to an embodiment. In particular, the shaped abrasive particle 400 can include a body 401 having the features of other shaped abrasive particles of embodiments herein, including an upper major surface 403 and a bottom major surface (not shown) opposite the upper major surface 403. The upper major surface 403 and the bottom major surface can be separated from each other by at least one side surface 405, which may include one or more discrete side surface portions, including for example, a first portion 406 of the side surface 405, a second portion 407 of the side surface 405, and a third portion 408 of the side surface 405. In particular, the first portion 406 of the side surface 405 can extend between a first corner 409 and a second corner 410. The second portion 407 of the side surface 405 can extend between the second corner 410 and a third corner 411. Notably, the second corner 410 can be an external corner joining two portions of the side surface 405. The second corner 410 and a third corner 411, which are also external corners, are adjacent to each other and have no other external corners disposed between them. Also, the third portion 408 of the side surface 405 can extend between the third corner 411 and the first corner 409, which are both external corners that are adjacent to each other and have no other external corners disposed between them.

As illustrated, the body 401 can have a perimeter defined by at least one linear section and at least one arcuate section. More particularly, the body 401 can include a first portion 406 including a first curved section 442 disposed between a first linear section 441 and a second linear section 443 and between the external corners 409 and 410. The second portion 407 is separated from the first portion 406 of the side surface 405 by the external corner 410. The second portion 407 of the side surface 405 can include a second curved section 452 joining a third linear section 451 and a fourth linear section 453. Furthermore, the body 401 can include a third portion 408 separated from the first portion 406 of the side surface 405 by the external corner 409 and separated from the second portion 407 by the external corner 411. The third portion 408 of the side surface 405 can include a third curved section 462 joining a fifth linear section 461 and a sixth linear section 463. In at least one embodiment, the body 401 may be a shape including a central region having three arms extending from the central region, each of the arms including tips including external corners (e.g., 409, 410, and 411) defined by a joint between two linear sections and at least one arcuate portion extending between two external corners. Moreover, as illustrated in FIG. 4A, the body 401 can have a two-dimensional shape having perimeter defined by at least three discrete linear portions (e.g., 441, 443, 451, 453, 461, and 463) and three discrete arcuate portions, wherein each of the three discrete arcuate portions (e.g., 441, 452, and 462) curved sections are separated from each other by at least one of discrete arcuate portions.

FIG. 4B includes a top view of a shaped abrasive particle 430 according to an embodiment. The tip sharpness of a shaped abrasive particle, which may be an average tip sharpness, may be measured by determining the radius of a best fit circle on an external corner 431 of the body 432. For example, turning to FIG. 4B, a top view of the upper major surface 433 of the body 432 is provided. At an external corner 431, a best fit circle is overlaid on the image of the body 432 of the shaped abrasive particle 430, and the radius of the best fit circle relative to the curvature of the external corner 431 defines the value of tip sharpness for the external corner 431. The measurement may be recreated for each external corner of the body 432 to determine the average individual tip sharpness for a single shaped abrasive particle 430. Moreover, the measurement may be recreated on a suitable sample size of shaped abrasive particles of a batch of shaped abrasive particles to derive the average batch tip sharpness. Any suitable computer program, such as ImageJ may be used in conjunction with an image (e.g., SEM image or light microscope image) of suitable magnification to accurately measure the best fit circle and the tip sharpness.

The shaped abrasive particles of the embodiments herein may have a particular tip sharpness that may facilitate suitable performance in the fixed abrasive articles of the embodiments herein. For example, the body of a shaped abrasive particle can have a tip sharpness of not greater than 80 microns, such as not greater than 70 microns, not greater than 60 microns, not greater than 50 microns, not greater than 40 microns, not greater than 30 microns, not greater than 20 microns, or even not greater than 10 microns. In yet another non-limiting embodiment, the tip sharpness can be at least 2 microns, such as at least 4 microns, at least 10 microns, at least 20 microns, at least 30 microns, at least 40 microns, at least 50 microns, at least 60 microns, or even at least 70 microns. It will be appreciated that the body can have a tip sharpness within a range between any of the minimum and maximum values noted above.

Another grain feature of shaped abrasive particles is the Shape Index. The Shape Index of a body of a shaped abrasive particle can be described as a value of an outer radius of a best-fit outer circle superimposed on the body, as viewed in two dimensions of a plane of length and width of the body (e.g., the upper major surface or the bottom major surface), compared to an inner radius of the largest best-fit inner circle that fits entirely within the body, as viewed in the same plane of length and width. For example, turning to FIG. 4C the shaped abrasive particle 470 is provided with two circles superimposed on the illustration to demonstrate the calculation of Shape Index. A first circle is superimposed on the body 470, which is a best-fit outer circle representing the smallest circle that can be used to fit the entire perimeter of the body 470 within its boundaries. The outer circle has a radius (Ro). For shapes such as that illustrated in FIG. 4C, the outer circle may intersect the perimeter of the body at each of the three external corners. However, it will be appreciated that for certain irregular or complex shapes, the body may not fit uniformly within the circle such that each of the corners intersect the circle at equal intervals, but a best-fit, outer circle still may be formed. Any suitable computer program, such as ImageJ may be used in conjunction with an image of suitable magnification (e.g., SEM image or light microscope image) to create the outer circle and measure the radius (Ro).

A second, inner circle can be superimposed on the body 470, as illustrated in FIG. 4C, which is a best fit circle representing the largest circle that can be placed entirely within the perimeter of the body 470 as viewed in the plane of the length and width of the body 470. The inner circle can have a radius (Ri). It will be appreciated that for certain irregular or complex shapes, the inner circle may not fit uniformly within the body such that the perimeter of the circle contacts portions of the body at equal intervals, such as shown for the shape of FIG. 4C. However, a best-fit, inner circle still may be formed. Any suitable computer program, such as ImageJ may be used in conjunction with an image of suitable magnification (e.g., SEM image or light microscope image) to create the inner circle and measure the radius (Ri).

The Shape Index can be calculated by dividing the outer radius by the inner radius (i.e., Shape Index=Ri/Ro). For example, the body 470 of the shaped abrasive particle has a Shape Index of approximately 0.35. Moreover, an equilateral triangle generally has a Shape Index of approximately 0.5, while other polygons, such as a hexagon or pentagon have Shape Index values greater than 0.5. In accordance with an embodiment, the shaped abrasive particles herein can have a Shape Index of at least 0.02, such as at least 0.05, at least 0.10, at least 0.15, at least 0.20, at least 0.25, at least 0.30, at least 0.35, at least 0.40, at least 0.45, at least about 0.5, at least about 0.55, at least 0.60, at least 0.65, at least 0.70, at least 0.75, at least 0.80, at least 0.85, at least 0.90, at least 0.95. Still, in another non-limiting embodiment, the shaped abrasive particle can have a Shape Index of not greater than 1, such as not greater than 0.98, not greater than 0.95, not greater than 0.90, not greater than 0.85, not greater than 0.80, not greater than 0.75, not greater than 0.70, not greater than 0.65, not greater than 0.60, not greater than 0.55, not greater than 0.50, not greater than 0.45, not greater than 0.40, not greater than 0.35, not greater than 0.30, not greater than 0.25, not greater than 0.20, not greater than 0.15, not greater than 0.10, not greater than 0.05, not greater than 0.02. It will be appreciated that the shaped abrasive particles can have a Shape Index within a range between any of the minimum and maximum values noted above.

FIG. 4D includes a top view of a shaped abrasive particle according to another embodiment. The shaped abrasive particle 480 can have a body 481 having the features of other shaped abrasive particles of embodiments herein, including an upper major surface 483 and a bottom major surface (not shown) opposite the upper major surface 483. The upper major surface 483 and the bottom major surface can be separated from each other by at least one side surface 484, which may include one or more discrete side surface sections. According to one embodiment, the body 481 can be defined as an irregular hexagon, wherein the body has a hexagonal (i.e., six-sided) two dimensional shape as viewed in the plane of a length and a width of the body 481, and wherein at least two of the sides, such as sides 485 and 486, have a different length with respect to each other. Notably, the length of the sides is understood herein to refer to the width of the body 481 and the length of the body is the greatest dimension extending through the midpoint of the body 481. Moreover, as illustrated, none of the sides are parallel to each other. And furthermore, while not illustrated, any of the sides may have a curvature to them, including a concave curvature wherein the sides may curve inwards toward the interior of the body 481.

The abrasive particles of the embodiments herein, which may include shaped abrasive particles and/or non-shaped abrasive particles, can have a particular composition that facilitates improved characteristics, including for example, a combination of suitable density and abrasive capabilities combined with a certain creep behavior. In particular, the abrasive particles can have a body including a first dopant, which may facilitate sintering and densification of the body and/or the formation of one or more additional phases in the body during sintering that facilitate the abrasive characteristics of the body. In one embodiment, the first dopant may include cobalt, magnesium, and a combination thereof. In more particular instances, the first dopant can include a majority content of magnesium and oxygen, and even more particularly, may consist essentially of magnesium and oxygen. For example, the first dopant can be magnesium oxide (MgO), and may consist essentially of magnesium oxide. In still another embodiment, the first dopant may include cobalt and oxygen, and may consist essentially of cobalt and oxygen.

In certain instances, the body of the abrasive particle can have a particular content of the first dopant that may facilitate the improved characteristics. For example, the body can include at least 0.1 wt % of the first dopant for the total weight of the body, such as at least 0.12 wt % or at least 0.15 wt % or at least 0.18 wt % or at least 0.2 wt % or at least 0.3 wt % or at least 0.4 wt % or at least 0.5 wt % or at least 0.6 wt % or at least 0.7 wt % or at least 0.8 wt % or at least 0.9 wt %. In yet another embodiment, the body of an abrasive particle may include not greater than 4.5 wt % of the first dopant for the total weight of the body, such as not greater than 4 wt % or not greater than 3 wt % or not greater than 2.5 wt % or not greater than 2.2 wt % or not greater than 2 wt % or not greater than 1.9 wt % or not greater than 1.8 wt % or not greater than 1.7 wt % or not greater than 1.6 wt % or not greater than 1.5 wt % or not greater than 1.4 wt % or not greater than 1.3 wt % or even not greater than 1.2 wt %. It will be appreciated that the body can include a content of the first dopant within a range including any of the minimum and maximum values noted above. Reference herein to the content of dopant material within a body of an abrasive particle can also be reference to an average content of the dopant for a group of abrasive particles, including for example a group of abrasive particles included in a fixed abrasive article. Moreover, different contents of the first dopant may be used to affect different behaviors. For example, smaller contents of the first dopant may be used to affect the densification of the body, wherein greater contents of the first dopant may be used to affect the abrasive behavior of the body.

In another aspect, the body of an abrasive particle can include a second dopant, which is distinct in composition from the first dopant by at least one element and which may also be distinct from the first dopant in terms of the distribution and/or placement within the body of the abrasive particle. The provision of a second dopant may facilitate certain improved characteristics of the abrasive particle, including for example, but not limited to creep and deformation characteristics related to improved grinding performance. According to one embodiment, the second dopant can include at least one element from the group consisting of yttrium, lanthanum, a rare-earth element, and a combination thereof. Rare-earth elements include those elements regarded as rare-earth elements according to the Periodic Table of Elements, which can include the seventeen elements including 15 lanthanide elements as well as scandium, and yttrium.

In at least one embodiment, the second dopant can include a material such as yttrium, and more particularly yttrium and oxygen, which may be in the form of a compound, such as yttrium oxide. In one particular instance, the second dopant can consist essentially of yttrium and oxygen. Other suitable materials which may be used as the second dopant can include zirconium, lanthanum, strontium, lutetium, neodymium, and a combination thereof.

In certain instances, the body can include a particular content of the second dopant to facilitate improved characteristics. For example, the body of the abrasive particle may include at least 0.1 wt % of the second dopant for the total weight of the body, such as at least 0.2 wt % or at least 0.4 wt % or at least 0.6 wt % or at least 0.8 wt % or at least 1 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or even at least 2 wt %. Still, in one non-limiting embodiment, the body of the abrasive particle can include not greater than 10 wt % of the second dopant for the total weight of the body, such as not greater than 9 wt % or not greater than 8 wt % or not greater than 7 wt % or not greater than 6 wt % or not greater than 5 wt % or not greater than 4 wt % or not greater than 3.5 wt % or not greater than 3.2 wt % or not greater than 3 wt % or not greater than 2.9 wt % or not greater than 2.8 wt % or not greater than 2.7 wt % or not greater than 2.6 wt % or not greater than 2.5 wt % or not greater than 2.4 wt % or not greater than 2.3 wt % or not greater than 2.2 wt % or even not greater than 2.1 wt %. It will be appreciated that the body of the abrasive particle can have a content of the second dopant within a range including any of the minimum and maximum percentages noted above. Further, it will be appreciated that reference to any of the percentages can be reference to an average percentage for a group or batch of abrasive particles, such as a group of abrasive particles incorporated into a fixed abrasive article.

According to at least one embodiment, the abrasive particle may utilize a relative content of the first and second dopants, which may facilitate improved characteristics and performance. For example, the abrasive particle may include a dopant ratio value (D1/D2) of at least 1, wherein D1 represents the weight percent of the first dopant in the body and D2 represent the weight percent of the second dopant in the body. In still other instances, the dopant ratio value (D1/D2) can be greater than 1, such as at least 1.1 or at least 1.2 or at least 1.3 or at least 1.4 or at least 1.5 or at least 1.6 or at least 1.7 or at least 1.8 or at least 1.9 or even at least 2. Still, in one non-limiting embodiment, the dopant ratio value (D1/D2) can be not greater than 10, such as not greater than 9 or not greater than 8 or not greater than 7 or not greater than 6 or not greater than 5 or not greater than 4 or not greater than 3.5 or not greater than 3 or not greater than 2.8 or not greater than 2.5. It will be appreciated that the body of the abrasive particle can have a dopant ratio (D1/D2) within a range including any of the minimum and maximum values noted above. Furthermore, it will be appreciated that reference to any of the values can be reference to an average value for a group or batch of abrasive particles, such as a group of abrasive particles incorporated into a fixed abrasive article.

In still other instances, the abrasive particle may utilize a relative content of the first and second dopants, which differs from the ratios noted above, and which may also facilitate improved characteristics and performance. For example, the abrasive particle may include a dopant ratio value (D2/D1) of at least 1, wherein D1 represents the weight percent of the first dopant in the body and D2 represent the weight percent of the second dopant in the body. In still other instances, the dopant ratio value (D2/D1) can be greater than 1, such as at least 1.1 or at least 1.2 or at least 1.3 or at least 1.4 or at least 1.5 or at least 1.6 or at least 1.7 or at least 1.8 or at least 1.9 or even at least 2. Still, in one non-limiting embodiment, the dopant ratio value (D2/D1) can be not greater than 10, such as not greater than 9 or not greater than 8 or not greater than 7 or not greater than 6 or not greater than 5 or not greater than 4 or not greater than 3.5 or not greater than 3 or not greater than 2.8 or not greater than 2.5. It will be appreciated that the body of the abrasive particle can have a dopant ratio (D2/D1) within a range including any of the minimum and maximum values noted above. Furthermore, it will be appreciated that reference to any of the values can be reference to an average value for a group or batch of abrasive particles, such as a group of abrasive particles incorporated into a fixed abrasive article.

According to one embodiment, the abrasive particle may be formed to have a particular distribution of the first dopant and/or second dopant within the body of the abrasive particle. For example, in certain instances, the first dopant can present as a first grain boundary phase and the second dopant can be present as a second grain boundary phase. Grain boundary phases may exist between the grains (i.e., crystallites) of other grains of material within the body, which may include for example, grains comprising alumina. The grain boundary phases may include one or more elements from one or more of the dopant materials. In one embodiment, the first grain boundary phase can be substantially homogeneous throughout the entire body of the abrasive particle. In more particular instances, the first grain boundary phase can be substantially homogeneous throughout the entire body of the abrasive particle. According to another aspect, the second grain boundary phase can be substantially homogeneous throughout the entire body of the abrasive particle.

FIG. 5A includes an illustration of a body of an abrasive particle including a dopant or phase substantially uniformly dispersed within the body. As illustrated, the abrasive particle 500 includes a body 201 that can be formed of a first phase 502 and a second phase 503. The second phase can include any of the dopant materials or phases as described in embodiments herein. As further illustrated, the second phase 503 can be substantially, uniformly dispersed throughout the volume of the body 501, such that if a statistically relevant and random sampling of different portions of the body 501 was obtained, the content of the second phase 503 between each of the different samplings would be substantially the same. In certain embodiments, the variation of the second phase, which may be based upon a standard deviation, may be not greater than about 20% of the average value of the second phase for the body, as calculated by the equation (AVG/STDEV)×100%, wherein AVG represents the average content of the second phase for each of the different portions and STDEV represents the standard deviation of the content of the second phase for the sampling.

Still, in at least one embodiment, the body of the abrasive particle can include a non-homogeneous distribution of the first and/or second dopant. For example, in one embodiment, at least one of the first dopant and second dopant are preferentially distributed in a higher concentration near the exterior surfaces of the body compared to the interior region surrounding a volumetric midpoint of the body. For example, in one aspect, the first dopant can have a higher concentration at a peripheral region of the body including and abutting an exterior surface of the body compared to a central region within the body spaced away from the exterior surface and surrounding a midpoint of the body. Moreover, in another embodiment, the second dopant can have a higher concentration at a peripheral region of the body including and abutting an exterior surface of the body compared to a central region within the body spaced away from the exterior surface and surrounding a midpoint of the body.

FIG. 5B includes an illustration of an abrasive particle including a dopant or phase of material non-uniformly dispersed within the body. As illustrated, the particulate material 510 can include a particle having a body 511 that can be formed of at least a first phase 502 and a second phase 503. The second phase 503 can be non-uniformly dispersed throughout the volume of the body 511. The second phase 503 can represent any one or more of the dopants or phases of material as referred to embodiments herein. In particular, the body 511 can include a greater content of the second phase 503 within a peripheral region 513 as compared to the content of the second phase 503 within the central region 515. In such instances, the second phase 513 appears to create a “halo” in the body 511. The peripheral region 513 of the body 511 can extend from the exterior surface 512 into the volume of the body 511 for a distance that encompasses at least a majority of the second phase 503. In particular instances, the peripheral region 513 can be defined by the region encompassing at least about 90% of the second phase between the exterior surface 512 and a boundary 514 between the exterior surface 512 and the volumetric midpoint 516 of the body. For example, the peripheral region 513 may include at least about 5%, such as at least about 10%, at least about 20%, or even at least about 25% of the total volume of the body. The central region 515 of the body 511 may be a region surrounding the volumetric midpoint 516 of the body and extending out in three dimensions to a boundary 514. The central region may be at least about 5%, such as at least about 10%, at least about 20% or even at least about 25% of the total volume of the body. The above illustration is not limiting, and it will be appreciated that various particles may be made to form a peripheral region and a central region of different sizes and shapes.

Reference herein to first and second phases may be non-limiting and it will be appreciated that other phase and/or compositions can exist within the abrasive particles of the embodiments herein in addition to only a first and second phase.

According to an embodiment, the abrasive particle can include a third dopant, which may be distinct from the first and/or second dopant in composition and/or distribution within the body of the abrasive particle. The third dopant may include a metal-containing compound, such as an oxide, and more particularly, a transition metal oxide compound. One suitable metal element includes cobalt. In one particular instance, the third dopant can consist essentially of cobalt or cobalt oxide. In yet another instance, the third dopant can include zirconium, lanthanum, strontium, lutetium, neodymium, and a combination thereof.

The third dopant may be a distinct phase from other phases within the body, including for example, the phase comprising the alumina material. Still, the third dopant need not be a distinct phase of material and can be incorporated into one or more other phases of material within the body.

In certain instances, the body can include a particular content of the third dopant to facilitate improved characteristics. For example, the body can include a content of the third dopant that is different than the content of the first or second dopants. The third dopant may be present in an amount that is less than the content of the first dopant. Moreover, the third dopant may be present in an amount that is less than the amount of the second dopant. The presence of the third dopant does not necessarily require the presence of the first or second dopant, and is merely selected as a general naming convention.

The body may include a particular content of the third dopant that can facilitate improved characteristics, including but not limited to abrasive behavior and/or deformation characteristics. For example, the content of the third dopant in the body can be at least 0.1 wt % of the third dopant for the total weight of the body, such as at least 0.2 wt % or at least 0.4 wt % or at least 0.6 wt % or at least 0.8 wt % or at least 1 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or even at least 2 wt %. Still, in one non-limiting embodiment, the body of the abrasive particle can include not greater than 10 wt % of the third dopant for the total weight of the body, such as not greater than 9 wt % or not greater than 8 wt % or not greater than 7 wt % or not greater than 6 wt % or not greater than 5 wt % or not greater than 4 wt % or not greater than 3.5 wt % or not greater than 3.2 wt % or not greater than 3 wt % or not greater than 2.9 wt % or not greater than 2.8 wt % or not greater than 2.7 wt % or not greater than 2.6 wt % or not greater than 2.5 wt % or not greater than 2.4 wt % or not greater than 2.3 wt % or not greater than 2.2 wt % or even not greater than 2.1 wt %. It will be appreciated that the body of the abrasive particle can have a content of the third dopant within a range including any of the minimum and maximum percentages noted above. Further, it will be appreciated that reference to any of the percentages can be reference to an average percentage for a group or batch of abrasive particles, such as a group of abrasive particles incorporated into a fixed abrasive article.

According to at least one embodiment, the abrasive particle may utilize a relative content of the first and third dopants, which may facilitate improved characteristics and/or performance. For example, the abrasive particle may include a dopant ratio value (D1/D3) of at least 1, wherein D1 represents the weight percent of the first dopant in the body and D3 represent the weight percent of the third dopant in the body. In still other instances, the dopant ratio value (D1/D3) can be greater than 1, such as at least 1.1 or at least 1.2 or at least 1.3 or at least 1.4 or at least 1.5 or at least 1.6 or at least 1.7 or at least 1.8 or at least 1.9 or even at least 2. Still, in one non-limiting embodiment, the dopant ratio value (D1/D3) can be not greater than 10, such as not greater than 9 or not greater than 8 or not greater than 7 or not greater than 6 or not greater than 5 or not greater than 4 or not greater than 3.5 or not greater than 3 or not greater than 2.8 or not greater than 2.5. It will be appreciated that the body of the abrasive particle can have a dopant ratio (D1/D3) within a range including any of the minimum and maximum values noted above. Furthermore, it will be appreciated that reference to any of the values can be reference to an average value for a group or batch of abrasive particles, such as a group of abrasive particles incorporated into a fixed abrasive article.

Moreover, the abrasive particle may utilize a relative content of the second and third dopants, which may facilitate improved characteristics and/or performance. For example, the abrasive particle may include a dopant ratio value (D2/D3) of at least 1, wherein D2 represents the weight percent of the second dopant in the body and D3 represent the weight percent of the third dopant in the body. In still other instances, the dopant ratio value (D2/D3) can be greater than 1, such as at least 1.1 or at least 1.2 or at least 1.3 or at least 1.4 or at least 1.5 or at least 1.6 or at least 1.7 or at least 1.8 or at least 1.9 or even at least 2. Still, in one non-limiting embodiment, the dopant ratio value (D2/D3) can be not greater than 10, such as not greater than 9 or not greater than 8 or not greater than 7 or not greater than 6 or not greater than 5 or not greater than 4 or not greater than 3.5 or not greater than 3 or not greater than 2.8 or not greater than 2.5. It will be appreciated that the body of the abrasive particle can have a dopant ratio (D2/D3) within a range including any of the minimum and maximum values noted above. Furthermore, it will be appreciated that reference to any of the values can be reference to an average value for a group or batch of abrasive particles, such as a group of abrasive particles incorporated into a fixed abrasive article.

According to at least one embodiment, the abrasive particle may have a particular composition that provides improved characteristics and/or performance. For example, the body can be essentially free of zirconium, cobalt, iron, calcium, carbides, nitrides, silicon, lithium, sodium, potassium, strontium, titanium, vanadium, chromium, manganese, nickel, copper, zinc, niobium, molybdenum, ruthenium, palladium, hafnium, tantalum, lanthanum, cerium, neodymium, scandium, zinc, and a combination thereof. As used herein, a body that is “essentially free of” a material is intended to refer to a content of that material that is less than 1 wt % of the body, such as less than 0.8 wt % of the body or less than 0.6 wt % of the body or less than 0.4 wt % of the body or less than 0.3 wt % of the body or less than 0.2 wt % of the body or less than 0.1 wt % of the body or less than 0.08 wt % of the body or less than 0.06 wt % of the body or less than 0.04 wt % of the body or less than 0.03 wt % of the body or less than 0.02 wt % of the body or less than 0.01 wt % of the body. “Essentially free” can also refer to a body that is absolutely free of the material (0 wt %). Bodies “essentially free of” a material may include minor content of the material, such as impurity content, or content below a measurable limit for certain characterization tools; however, bodies which are “essentially free of” certain materials are not notably impacted by impurity content of the material. The foregoing does not limit the foregoing elements from all compositions of the embodiments herein, but provides a list of elements that may not necessarily exist within the abrasive particle in limited instances.

In at least one particular embodiment, the body may be essentially free of certain elements and compositions including such elements, including for example, but not limited to rare-earth metal elements. In more particular, terms, the body can be essentially free of praseodymium, samarium, ytterbium, neodymium, lanthanum, gadolinium, cerium, dysprosium, erbium, and a combination thereof.

According to one particular embodiment, the body can consist essentially of alpha alumina, magnesium-containing oxides, and at least one of a yttrium-containing oxide, lanthanum-containing oxide, and/or a rare-earth containing oxide. In the one particular embodiment, the content of alpha alumina can be greater than the content of magnesium-containing oxide within the body, and the content of the magnesium-containing oxide can be greater than the content of at least one of the yttrium-containing oxide, the lanthanum-containing oxide, and/or the rare-earth containing oxide.

In one embodiment, the body of the abrasive particle can include a grain boundary phase comprising yttrium, aluminum, and oxygen. The grain boundary phase can be located primarily, if not entirely, within the grain boundaries of the body. The grain boundary phase may be disposed between the crystallites of alumina at the grain boundaries. More particularly, the grain boundary phase can be preferentially located at triple point boundaries joining three or more crystallites. According to one embodiment, the grain boundary phase can include an oxide compound including yttrium and aluminum. For example, the grain boundary phase can include a yttrium aluminate compound, and may consist essentially of yttrium aluminate. It will be appreciated that any one of the grain boundary phases mentioned herein can include a crystalline material, a polycrystalline material and the like. Moreover, any one of the grain boundary phases noted in the embodiments herein can be bonded to the surrounding grains. Still, in certain instances, one or more different grain boundary phases may exist. In certain other instances, the body can include a grain boundary phase including spinel composition comprising magnesium, aluminum and oxygen. The grain boundary phase including the spinel composition may be present with one or more grain boundary phases described herein.

The abrasive particles of the embodiments herein can have a particular hardness that may facilitate improved performance. For example, the abrasive particles of the embodiments herein can have a Vickers hardness, as measured according to ASTM C1327 of at least 20 GPa, such as at least 20.5 GPa or at least 21 GPa or at least 21.5 GPa or even at least 22 GPa. Still, in one non-limiting embodiment, the Vickers hardness can be not greater than 40 GPa, such as not greater than 30 GPa or even not greater than 28 GPa. It will be appreciated that the abrasive particles can have a hardness within a range including any of the minimum and maximum values noted above.

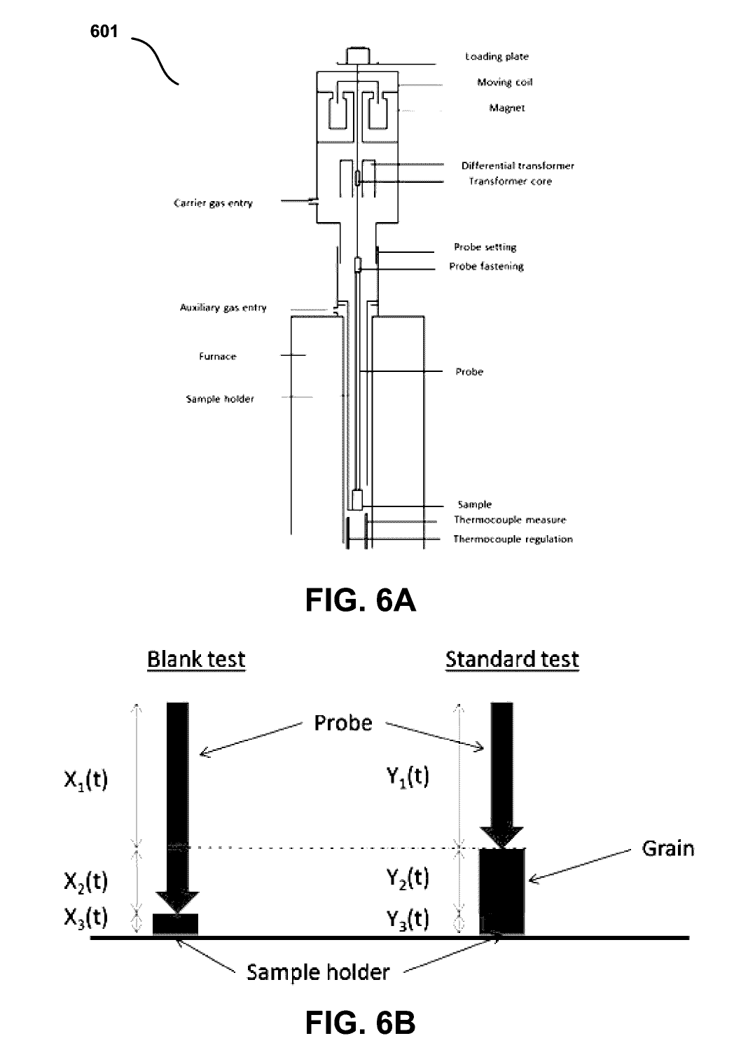

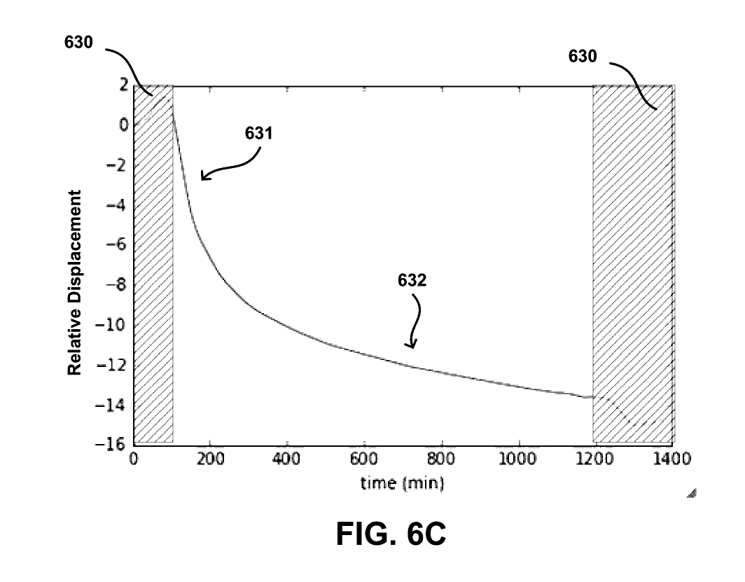

The abrasive particles of the embodiments herein have demonstrated a particularly unique performance as evaluated according to a standardized creep test, which may relate to superior grinding performance. The deformation characteristics of the abrasive particles can be measured by a standardized creep test, using a ThermoMechanical Analyzer (Make: SETARAM, Model: SETSYS Evolution TMA 2400) to measure strain as a function of time, at high temperature. FIG. 6A includes a schematic view of the apparatus used to measure the creep of the abrasive particles. During the testing, the loading plate is set for a 200 g mechanical load. In addition, the probe can electronically apply a 150 g load on the sample. The probe is silicon carbide (available as Hexaloy from Saint-Gobain), which has a significantly higher creep resistance than the samples, and thus allows us to neglect the deformation of the probe during the experiment. The probe tip has a 1 mm² area. The applied load on the sample is 350 g (200 g mechanically and 150 g electronically). Locally, a grain undergoes a pressure of 15.1 MPa. The sample is placed on a specimen holder (in alumina).

During testing, the sample is placed in the heating chamber (in Argon and at atmospheric pressure) and under the probe. The temperature is measured by a thermocouple in tungsten. Temperature rises from room temperature to 1200° C. in 2 hours (10° C. per minute), is held at 1200° C. for 18 hours, and finally decreases from 1200° C. to room temperature in 2.5 hours.

Data analyses and processing are conducted by the software Calisto, which is available from Advanced Kinetics and Technology Solutions. For each campaign of test runs, a blank sample is first run in order to record the dilatation of the probe and the sample holder. A blank curve is created as a manner of calibrating the system before conducting test runs on samples. One or more standard tests are then conducted using the desired samples to create raw data curves of the creep behavior. See, FIG. 6B for the difference in the blank test and the standard test. When plotting the data from the test runs, the blank curve is subtracted from the raw data curve according to the equations below.

Raw data curve:

Y2(t)−Y2(0)+Y3(t)−Y3(0)+Dprobe(Y1(t))

Raw data curve minus the blank curve:

Y2(t)−Y2(0)+Y3(t)−Y3(0)+Dprobe(Y1(t))−[X3(t)−X3(0)+Dprobe(X2(t))+Dprobe(X1(t))]=Y2(t)−Y2(0)−Dprobe(X2(t))

Raw data curve minus the blank curve, corrected by the dilatation of the portion of the probe that correspond to the grain size:

Y2(t)−Y2(0)+Y3(t)−Y3(0)+Dprobe(Y1(t))−[X3(t)−X3(0)+Dprobe(X2(t))+Dprobe(X1(t))]+Dprobe(X2(t))=Y2(t)−Y2(0)

Notably, Dprobe(L) is the measure of the dilatation of a piece of the probe of length L. At certain times, the following equalities exist: Y1(t)=X1(t), Y2(t), X2(t) and Y3(t)=X3(t)

Hence, the final plot represents the strain of the grain without the influence of the probe dilatation, which may appear to have the shape generally of the plot provided in FIG. 6C. Note that for a shaped abrasive particle having two major surfaces defining the length and width and a side surface defining the height of the particle, the shaped abrasive particles were laying on a major surface during testing and thus the dilatation is measured in the dimension of the height of the particle body.

During further analysis, the portions 630 of the plot provided in FIG. 6C are removed. The portion 630 represents times during heating or cooling of the sample and not representative of the isothermal behavior of the material between 120 to 1200 minutes. Further analysis is based on the isothermal behavior of the sample in the primary regime 631 and secondary regime 632 between 120 to 1200 minutes during the isothermal region of the test.

A best first curve is then fit to each plot. Based on the generalized plot provided in FIG. 6C, it has been found that plot in the primary regime 631 may have a best fit line defined by an attenuating exponential-like equation, while the plot in the secondary regime 632 may have a best fit line defined by a linear equation. Therefore, for each plot, the curve in the primary regime is fitted with a curve according to the equation:

If t<thrsh: Creep curve=A*(−b+exp(−t/τ))

And the curve in the secondary regime 632 is fitted with a curve according to the equation:

If t≧thrsh: Creep curve=A*(−b+exp(−t/τ))−r*(t−thrsh)

Notably, “thrsh” represents the beginning of the secondary regime, “t” represents the time in minute, “A” represents the amplitude of the primary regime, “b” represents the affix of the exponential, “r” represents the characteristic time of the primary regime, “r” represents the rate in the secondary regime, and “c” represents the affix of the straight line. The variables, “thrsh”, “A”, “b”, “τ”, “r” and “c” are the parameters that are fitted by the model. The method used for the fit is called the least square estimation. Notably, the variable “A” defines the primary deformation amplitude in percent, “τ” represents the primary deformation time (in minutes), “r” represents the secondary deformation characteristic rate percent/minute.

In accordance with one embodiment, the abrasive particles of the embodiments herein can have one or more particular deformation characteristics, which may be evaluated according to the standardized creep test, and which may facilitate improved grinding performance. Without wishing to be tied to a particular theory, it is thought that the abrasive particles of the embodiments herein can have a certain primary deformation amplitude (A), which may indicate the likelihood of the abrasive particle to plastically deform under a load, wherein a smaller primary deformation amplitude may indicate a particle that is less likely to plastically deform and thus exhibit better grinding performance compared to a particle having a higher primary deformation amplitude (A). According to one embodiment, the abrasive particles can have a primary deformation amplitude (A) of not greater than 30 percent as calculated by the formula [(L−L0)/L0]*100, such as not greater than 25 percent or not greater than 20 percent or not greater than 18 percent or not greater than 16 percent or not greater than 14 percent or not greater than 13 percent or not greater than 12 percent or not greater than 11 percent or not greater than 10 percent or not greater than 9 percent or not greater than 8 percent or not greater than 7 percent or not greater than 6 percent or even not greater than 5 percent. Still, in one non-limiting embodiment, the primary deformation amplitude (A) can be at least 0.01 percent, such as at least 0.1 percent. It will be appreciated that the primary deformation amplitude (A) can be within a range including any of the minimum and maximum values noted above.

The abrasive particles of the embodiments herein may have a certain primary deformation time, which may be an indication of the likelihood of a particle to plastically deform, wherein a smaller primary deformation time may facilitate improved performance. For example, the abrasive particles of the embodiments herein can have a primary deformation time of not greater than 280 minutes, such as not greater than 250 minutes or not greater than 230 minutes or not greater than 200 minutes or not greater than 180 minutes or not greater than 160 minutes or even not greater than 150 minutes. Still, in at least one non-limiting embodiment, the abrasive particles can have a primary deformation time of at least 100 minutes, such as at least 110 minutes or at least 120 minutes or at least 130 minutes or even at least 140 minutes. It will be appreciated that the abrasive particles can have a primary deformation time within a range including any of the minimum and maximum values noted above.

The abrasive particles of the embodiments herein may have a certain primary deformation amplitude and time multiplier value, which may be an indication of the likelihood of a particle to plastically deform over a given time, wherein a smaller primary deformation amplitude and time multiplier may facilitate improved performance. For example, the abrasive particles of the embodiments herein can have a primary deformation amplitude and time value of not greater than 700 percent minutes as calculated by the formula [[(L−L0)/L0]*100]*min, such as not greater than 690 percent minutes or not greater than 680 percent minutes or not greater than 670 percent minutes or not greater than 660 percent minutes or not greater than 650 percent minutes or not greater than 640 percent minutes or not greater than 630 percent minutes or not greater than 620 percent minutes or not greater than 610 percent minutes or not greater than 600 percent minutes or not greater than 590 percent minutes or not greater than 580 percent minutes or not greater than 570 percent minutes or even not greater than 560 percent minutes. Still, in at least one non-limiting embodiment, the abrasive particles can have a primary deformation amplitude and time multiplier of at least 100 percent minutes, such as at least 150 percent minutes or even at least 200 percent minutes. It will be appreciated that the abrasive particles can have a primary deformation amplitude and time multiplier within a range including any of the minimum and maximum values noted above.

In still another aspect, the abrasive particles of the embodiments herein may have a certain secondary deformation characteristic rate, which may be an indication of the likelihood of a particle to plastically deform over a long period of time, wherein a secondary deformation characteristic rate may facilitate improved performance. According to one embodiment, the abrasive particles can have a secondary deformation characteristic rate of not greater than 6×10⁻³ percent/minute as calculated by the formula [(L−L0)/L0]*100/min, such as not greater than 4×10⁻³ percent/minute or not greater than 2×10⁻³ percent/minute or not greater than 1×10⁻³ percent/minute or not greater than 8×10⁻⁴ percent/minute or not greater than 5×10⁻⁴ percent/minute or not greater than 1×10⁻⁴ percent/minute or not greater than 5×10⁻⁵ percent/minute or not greater than 1×10⁻⁵ percent/minute or not greater than 5×10⁻⁶ percent/minute or not greater than 1×10⁻⁶ percent/minute or not greater than 5×10⁻⁷ percent/minute or not greater than 1×10⁻⁷ percent/minute or not greater than 5×10⁻⁸ percent/minute. Still, in one non-limiting embodiment, the abrasive particles can have a secondary deformation characteristic rate of at least 1×10⁻¹² percent/minute or at least 1×10⁻¹° percent/minute. It will be appreciated that the abrasive particles can have a secondary deformation characteristic rate within a range including any of the minimum and maximum values noted above.

The abrasive particles of the embodiments herein may include one or more microstructural characteristics and/or deformation characteristics that may facilitate improved performance. For example, the abrasive particles can have one or more microstructural characteristics, including for example, an average crystal size of not greater than 6 microns or a hardness of at least 20 GPa. Moreover, it will be appreciated that the abrasive particles of the embodiments herein can have a combination of more than one particular microstructural feature, including for example, an average crystal size of not greater than 6 microns and a hardness of at least 20 GPa. Moreover, the abrasive particles may have one or more certain deformation characteristics, including any of the deformation characteristics as described herein. In one particular embodiment, the abrasive particles can include at least one deformation characteristic including a primary deformation amplitude of not greater than 30 percent, a primary deformation time of not greater than 280 minutes or a secondary deformation characteristic rate of not greater than 6×10⁻³ percent/minute. Still, it will be appreciated that at least one embodiment, can include a combination of more than one deformation characteristic, including but not limited to, a primary deformation amplitude of not greater than 30 percent, a primary deformation time of not greater than 280 minutes, and a secondary deformation characteristic rate of not greater than 6×10⁻³ percent/minute.

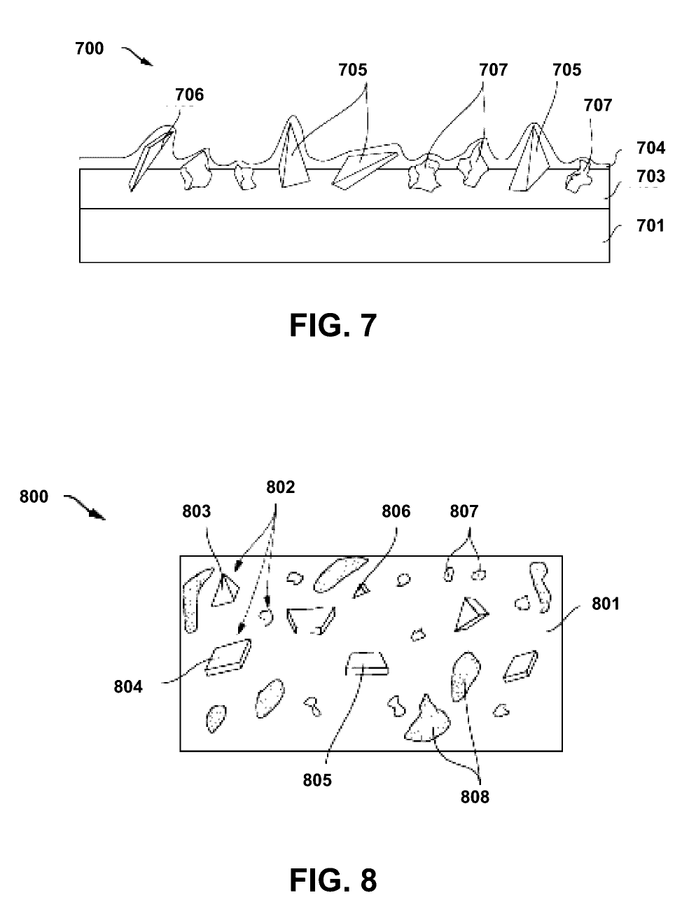

The abrasive particles of the embodiments herein may be incorporated into fixed abrasive articles, including but not limited to bonded abrasives, coated abrasives, non-woven abrasives, abrasive brushes, and the like. The abrasive particles may also be utilized as free abrasives, such as in slurries. FIG. 7 includes a cross-sectional illustration of a coated abrasive article incorporating the abrasive particulate material in accordance with an embodiment. As illustrated, the coated abrasive 700 can include a substrate 701 and a make coat 703 overlying a surface of the substrate 701. The coated abrasive 700 can further include a first type of abrasive particulate material 705 in the form of a first type of shaped abrasive particle, a second type of abrasive particulate material 706 in the form of a second type of shaped abrasive particle, and a third type of abrasive particulate material in the form of diluent abrasive particles, which may not necessarily be shaped abrasive particles, and having a random shape. The coated abrasive 700 may further include size coat 704 overlying and bonded to the abrasive particulate materials 705, 706, 707, and the make coat 704.

According to one embodiment, the substrate 701 can include an organic material, inorganic material, and a combination thereof. In certain instances, the substrate 701 can include a woven material. However, the substrate 701 may be made of a non-woven material. Particularly suitable substrate materials can include organic materials, including polymers, and particularly, polyester, polyurethane, polypropylene, polyimides such as KAPTON from DuPont, paper. Some suitable inorganic materials can include metals, metal alloys, and particularly, foils of copper, aluminum, steel, and a combination thereof.

The make coat 703 can be applied to the surface of the substrate 701 in a single process, or alternatively, the abrasive particulate materials 705, 706, 707 can be combined with a make coat 703 material and the combination of the make coat 703 and abrasive particulate materials 705-707 can be applied as a mixture to the surface of the substrate 701. In certain instances, controlled deposition or placement of the abrasive particles in the make coat may be better suited by separating the processes of applying the make coat 703 from the deposition of the abrasive particulate materials 705-707 in the make coat 703. Still, it is contemplated that such processes may be combined. Suitable materials of the make coat 703 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 703 can include a polyester resin. The coated substrate can then be heated in order to cure the resin and the abrasive particulate material to the substrate. In general, the coated substrate 701 can be heated to a temperature of between about 100° C. to less than about 250° C. during this curing process.

The abrasive particulate materials 705, 706, and 707 can include different types of shaped abrasive particles according to embodiments herein. The different types of shaped abrasive particles can differ from each other in composition, two-dimensional shape, three-dimensional shape, size, and a combination thereof as described in the embodiments herein. As illustrated, the coated abrasive 700 can include a first type of shaped abrasive particle 705 having a generally triangular two-dimensional shape and a second type of shaped abrasive particle 706 having a quadrilateral two-dimensional shape. The coated abrasive 700 can include different amounts of the first type and second type of shaped abrasive particles 705 and 706. It will be appreciated that the coated abrasive may not necessarily include different types of shaped abrasive particles, and can consist essentially of a single type of shaped abrasive particle. As will be appreciated, the shaped abrasive particles of the embodiments herein can be incorporated into various fixed abrasives (e.g., bonded abrasives, coated abrasive, non-woven abrasives, thin wheels, cut-off wheels, reinforced abrasive articles, and the like), including in the form of blends, which may include different types of shaped abrasive particles, shaped abrasive particles with diluent particles, and the like. Moreover, according to certain embodiments, batch of particulate material may be incorporated into the fixed abrasive article in a predetermined orientation, wherein each of the shaped abrasive particles can have a predetermined orientation relative to each other and relative to a portion of the abrasive article (e.g., the backing of a coated abrasive).

The abrasive particles 707 can be diluent particles different than the first and second types of shaped abrasive particles 705 and 706. For example, the diluent particles can differ from the first and second types of shaped abrasive particles 705 and 706 in composition, two-dimensional shape, three-dimensional shape, size, and a combination thereof. For example, the abrasive particles 707 can represent conventional, crushed abrasive grit having random shapes. The abrasive particles 707 may have a median particle size less than the median particle size of the first and second types of shaped abrasive particles 705 and 706.

After sufficiently forming the make coat 503 with the abrasive particulate materials 705, 706, 707 contained therein, the size coat 704 can be formed to overlie and bond the abrasive particulate material 705 in place. The size coat 704 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

FIG. 8 includes an illustration of a bonded abrasive article incorporating the abrasive particulate material in accordance with an embodiment. As illustrated, the bonded abrasive 800 can include a bond material 801, abrasive particulate material 802 contained in the bond material, and porosity 808 within the bond material 801. In particular instances, the bond material 801 can include an organic material, inorganic material, and a combination thereof. Suitable organic materials can include polymers, such as epoxies, resins, thermosets, thermoplastics, polyimides, polyamides, and a combination thereof. Certain suitable inorganic materials can include metals, metal alloys, vitreous phase materials, crystalline phase materials, ceramics, and a combination thereof.

The abrasive particulate material 802 of the bonded abrasive 800 can include different types of shaped abrasive particles 803, 804, 805, and 806, which can have any of the features of different types of shaped abrasive particles as described in the embodiments herein. Notably, the different types of shaped abrasive particles 803, 804, 805, and 806 can differ from each other in composition, two-dimensional shape, three-dimensional shape, size, and a combination thereof as described in the embodiments herein.

The bonded abrasive 800 can include a type of abrasive particulate material 807 representing diluent abrasive particles, which can differ from the different types of shaped abrasive particles 803, 804, 805, and 806 in composition, two-dimensional shape, three-dimensional shape, size, and a combination thereof.

The porosity 808 of the bonded abrasive 800 can be open porosity, closed porosity, and a combination thereof. The porosity 808 may be present in a majority amount (vol %) based on the total volume of the body of the bonded abrasive 800. Alternatively, the porosity 808 can be present in a minor amount (vol %) based on the total volume of the body of the bonded abrasive 800. The bond material 801 may be present in a majority amount (vol %) based on the total volume of the body of the bonded abrasive 800. Alternatively, the bond material 801 can be present in a minor amount (vol %) based on the total volume of the body of the bonded abrasive 800. Additionally, abrasive particulate material 802 can be present in a majority amount (vol %) based on the total volume of the body of the bonded abrasive 800. Alternatively, the abrasive particulate material 802 can be present in a minor amount (vol %) based on the total volume of the body of the bonded abrasive 800.

At least one of the abrasive particles in accordance with an embodiment herein can have a 1000° C. Vickers Hot Hardness, as measured according to the hot hardness test described below, of at least 12.0 GPa or at least 12.2 GPa or at least 12.5 GPa or at least 12.7 GPa or at least 13.0 GPa or at least 13.3 GPa or at least 13.5 GPa. At least one of the abrasive particles in accordance with another embodiment herein can have a 1000° C. Vickers Hot Hardness of no greater than 20 GPa, such as no greater than 18 GPa or no greater than 15 GPa. It will be appreciated that at least one abrasive particle can have a 1000° C. Vickers Hot Hardness within a range including any of the minimum and maximum values noted above. It will further be noted that any of the foregoing values related to 1000° C. Vickers Hot Hardness can be an average value for a batch of abrasive particles or average value for a statistically relevant sample size from a batch of abrasive particles.

In yet another embodiment, at least one abrasive particle can have a 800° C. Vickers Hot Hardness of at least 14.5 GPa or at least 15.0 GPa or at least 15.5 GPa or at least 16.0 GPa or at least 16.5 GPa or at least 17.0 GPa or at least 17.5 GPa or at least 18.0 GPa. In yet another embodiment, at least one of the abrasive particles can have 800° C. Vickers Hot Hardness of no greater than 25 GPa or no greater than 23 GPa or no greater than 21 GPa or no greater than 20 GPa. It will be appreciated that at least one abrasive particle can have a 800° C. Vickers Hot Hardness within a range including any of the minimum and maximum values noted above. It will further be noted that any of the foregoing values related to 800° C. Vickers Hot Hardness can be an average value for a batch of abrasive particles or average value for a statistically relevant sample size from a batch of abrasive particles.

In yet a further embodiment, at least one abrasive particle can have a 600° C. Vickers Hot Hardness of at least 19 GPa or at least 19.5 GPa or at least 20.0 GPa or at least 20.5 GPa or at least 21.0 GPa or at least 21.5 GPa or at least 22.0 GPa. In another embodiment, at least one of the abrasive particles can have a 600° C. Vickers Hot hardness of no greater than 27.0 GPa or no greater than 25.0 GPa or no greater than 23.0 GPa. It will be appreciated that at least one abrasive particle can have a 600° C. Vickers Hot Hardness within a range including any of the minimum and maximum values noted above. It will further be noted that any of the foregoing values related to 600° C. Vickers Hot Hardness can be an average value for a batch of abrasive particles or average value for a statistically relevant sample size from a batch of abrasive particles.

In another embodiment, at least one abrasive particle can have a 400° C. Vickers Hot Hardness of at least 19.0 GPa or at least 19.5 GPa or at least 20.0 GPa or at least 20.5 GPa or at least 21.0 GPa or at least 21.5 GPa or at least 22.0 GPa or at least 22.5 GPa or at least 23.0 GPa. In another embodiment, at least one of the abrasive particles can have a 400° C. Vickers Hot Hardness of no greater than 35.0 GPa or no greater than 31.0 GPa or no greater than 27.0 GPa or no greater than 24.0 GPa. It will be appreciated that at least one abrasive particle can have a 400° C. Vickers Hot Hardness within a range including any of the minimum and maximum values noted above. It will further be noted that any of the foregoing values related to 400° C. Vickers Hot Hardness can be an average value for a batch of abrasive particles or average value for a statistically relevant sample size from a batch of abrasive particles. It is noted that unless indicated otherwise such as with the specification of Vickers Hot Hardness, hardness measurements described herein pertain to room temperature hardness.

### EXAMPLES

### Example 1

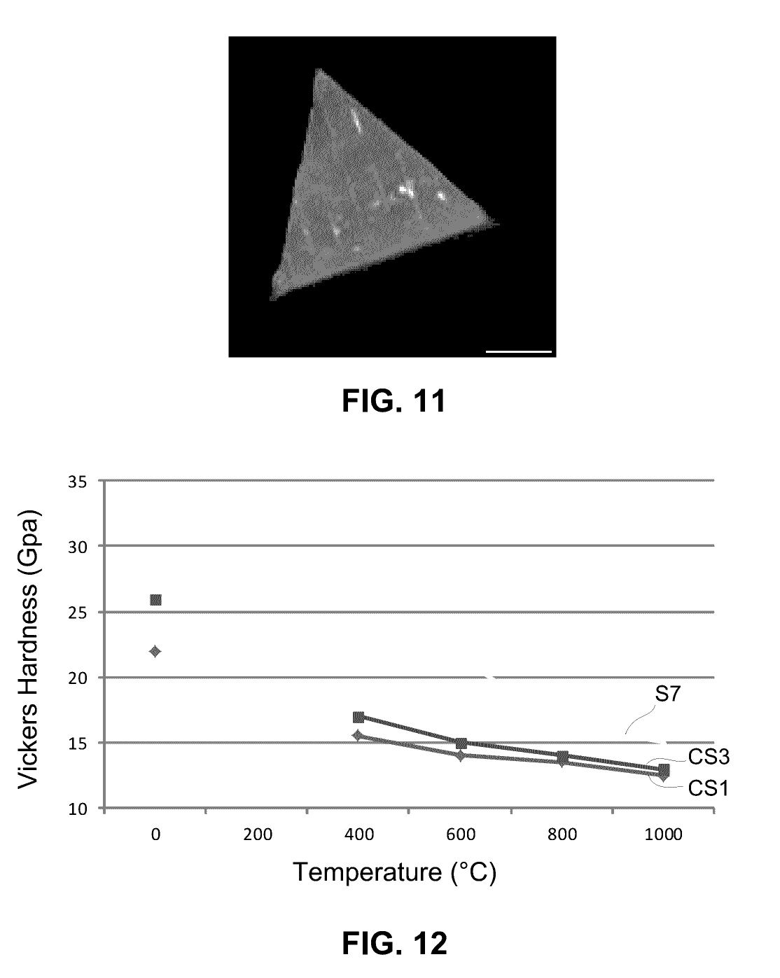

Five samples were obtained or prepare and tested for comparison to evaluate the high temperature creep performance and abrasive performance. A first comparative sample (CS1) was a conventional shaped abrasive particle commercially available in 3M984F coated abrasive products from 3M Corporation. FIG. 11 includes an image of a shaped abrasive particle for sample CS 1. CS 1 is made primarily of alpha alumina having an average crystal size of approximately 7-8 microns and a composition including approximately 1.2 wt % Y₂O₃, 1 wt % MgO, 4 wt % La₂O₃, 0.04 wt % CoO, and 0.1 wt % TiO₂.

A second comparative sample (CS2) was a conventional shaped abrasive particle commercially available in 3M994F coated abrasive products from 3M. The shaped abrasive particle of this sample had a shape similar to that as illustrated in FIG. 11. CS2 is made primarily of alpha alumina having an average crystal size of approximately 7-8 microns and a composition including approximately 1 wt % Y₂O₃, 1.4 wt % MgO, 2 wt % La₂O₃, 0.04 wt % CoO, and 0.1 wt % TiO₂.

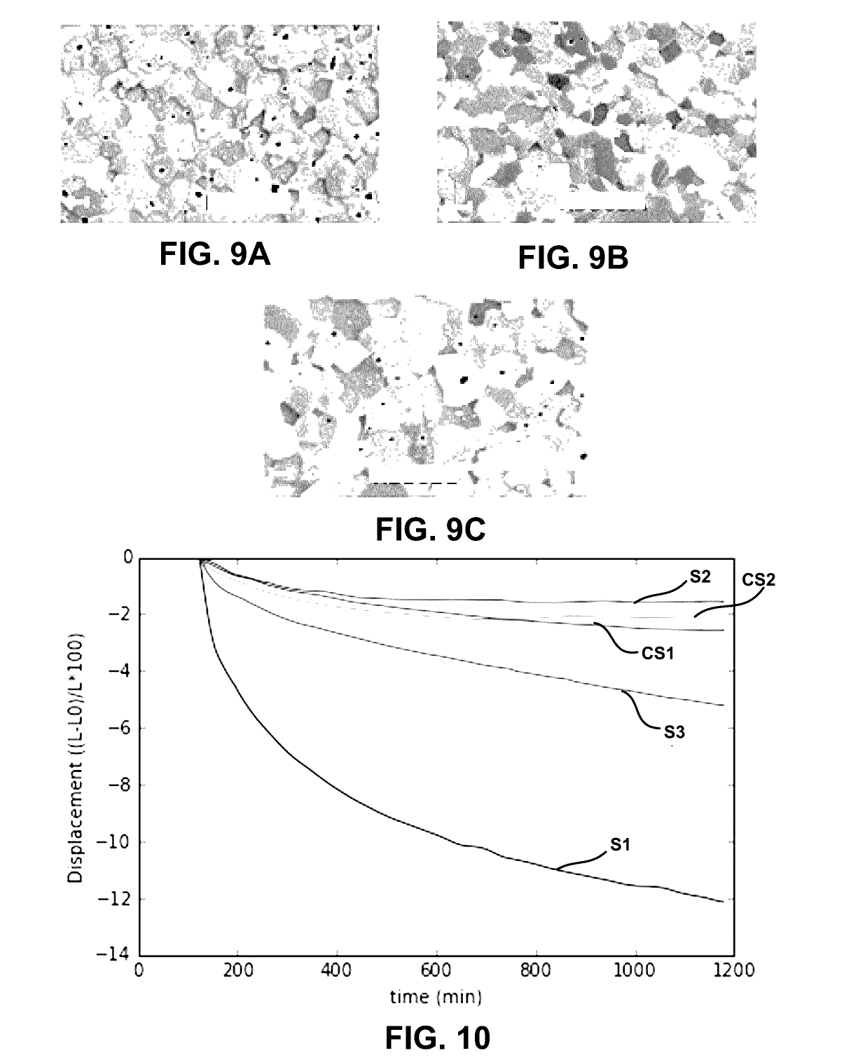

Three other individual samples (S1, S2, and S3) were prepared from a gel including 41.5 wt % boehmite commercially available as Reflux Catapal B and seeded with 1% alpha alumina seeds and dopants in the weight percentages as provided in Table 1. The mixture also included 55 wt % water and 2.5 wt % nitric acid. The mixture was extruded into triangular shaped openings in a production tool, wherein the triangular shaped openings had a length of 2.77 mm, a width of 2.4 mm and a depth (height) of 0.53 mm. The production tool was made of metal. The surfaces of the openings in the production tool were coated with a lubricant of olive oil to facilitate removal of the precursor shaped abrasive particles from the production tool. The mixture was dried in the openings at approximately 50° C. for 10 minutes. The mixture was then removed from the openings of the production tool and sintered at the temperatures provided in Table 1 for approximately 10 minutes to obtain the average crystal size and density as also reported in Table 1. SEM micrograph images of each of the samples S1-S3 are provided in FIGS. 9A-9C, respectively.

TABLE 1

| | Sintering | Crystal | Density | |
|---|---|---|---|---|
| Grain | temperature | size | (% | Doping |
| reference | (° C.) | (nm) | theoretical) | (wt %) |
| Si | 1300 | 220 | 97.7 | None |
| (RB299A) | | | | |
| S2 | 1450 | 390 | 99.7 | 1.1% MgO |
| (RB303A) | | | | 2.1% Y₂O₃ |
| S3 | 1375 | 190 | 99.1 | 2.8% MgO |
| (RB303B) | | | | 0.43% Y₂O₃ |

FIG. 10 includes plots of displacement versus time for certain exemplary and comparative samples according to the high temperature creep test. Notably, as illustrated, Sample S2 demonstrated the best creep behavior compared to all other samples, with a primary deformation amplitude of 3.6 percent, a primary deformation time of 155 minutes, and a secondary deformation characteristic rate of 1.5×10⁻⁸ percent/min. Sample S1 had a primary deformation amplitude of 19.4 percent, a primary deformation time of 139 minutes, and a secondary deformation characteristic rate of 3.7×10⁻³ percent/minute. Sample S3 had a primary deformation amplitude of 7.1 percent, a primary deformation time of 124 minutes, and a secondary deformation characteristic rate of 3.0×10⁻³ percent/minute. Sample CS1 had a primary deformation amplitude of 3.4 percent, a primary deformation time of 273 minutes, and a secondary deformation characteristic rate of 6.0×10⁻⁴ percent/minute. Sample CS2 had a primary deformation amplitude of 4.4 percent, a primary deformation time of 166 minutes, and a secondary deformation characteristic rate of 1.1×10⁻⁸ percent minute.

### Example 2

Twelve samples are obtained or to be prepared and a portion of which are tested for comparison to evaluate hot hardness performance and abrasive performance. A first comparative sample is CS1 described above in Example 1. CS 1 is a conventional shaped abrasive particle commercially available in 3M984F coated abrasive products from 3M Corporation.

A third comparative sample (CS3) is a pure seeded gel shaped abrasive particle. The shaped abrasive particle has a shape similar to that illustrated in FIG. 11. CS3 is made primarily of alpha alumina (at least 99.7 wt % alumina) having an average crystal size of approximately 0.31 microns

Ten other individual samples (S4, S5, S6, S7, S8, S9, S10, S11, S12) are prepared from a gel including 48.3 wt % boehmite commercially available as Reflux Catapal B and seeded with 0.35 wt % alpha alumina seeds and dopants in the weight percentages as provided in Table 2. The samples are doped by impregnation with yttrium nitrate hexahydrate and magnesium nitrate hexahydrate as doping precursors. The mixtures also include 50 wt % water and 1.3 wt % nitric acid. The mixture is extruded into triangular shaped openings in a production tool, wherein the triangular shaped openings have a length of 2.77 mm, a width of 2.4 mm, and a depth (height) of 0.51 mm. The production tool is made of metal. The opening surfaces of the openings in the production tool are coated with a lubricant of olive oil to facilitate removal of the precursor shaped abrasive particles from the production tool. The mixture is dried in the openings at approximately 50° C. for 10 minutes. The mixture is then removed from the openings of the production tool and sintered at temperatures between 1300° C. and 1400° C. The samples are then coated onto an abrasive belt with a number of cutting points per square centimeter in a range of 40 to 45.

Hot hardness is tested using a Nikon QM hot hardness tester. The equipment is capable of testing samples at temperatures up to 1000° C. The sample is mounted in a heating chamber which is subsequently evacuated. During testing, the vacuum level is monitored and the temperature of the indenter and sample is measured by thermocouples. Testing is performed using a diamond Vickers indenter at temperatures in 200° C. intervals from 400° C. to 1000° C. The test cycle is approximately 45 minutes with hold segments from 3-4 minutes. During the hold segment, three to five indentations are performed. The indentation load is 375 g.

The samples have polished flat and parallel sides and are mounted on a 5×5×10 mm alumina block using high temperature cement. Each sample holder has two samples mounted thereon.

Hardness of the samples is calculated from the measured indents according to the Vickers method for ceramics (ASTM C1327).

TABLE 2

| | | Sintering | Crystal | Density |
|---|---|---|---|---|
| Grain | Doping | temperature | size | (% |
| reference | (wt %) | (° C.) | (nm) | theoretical) |
| CS1 | None | 1300-1400 | Data Not | 98.5-99.5 |
| CS3 | None | | Yet | |
| S4 | 0.5% MgO | | Available | |
| (To be | 0.5% Y₂O₃ | | | |
| Formed) | | | | |
| S5 | 0.5% MgO | | | |
| (To be | 5.0% Y₂O₃ | | | |
| Formed) | | | | |
| S6 | 0.5% MgO | | | |
| (To be | 8.0% Y₂O₃ | | | |
| Formed) | | | | |
| S7 | 1.0% MgO | | | |
| | 2.0% Y₂O₃ | | | |
| S8 | 2.0% MgO | | | |
| (To be | 0.5% Y₂O₃ | | | |
| Formed) | | | | |
| S9 | 2.0% MgO | | | |
| (To be | 5.0% Y₂O₃ | | | |
| Formed) | | | | |
| S10 | 2.0% MgO | | | |
| (To be | 8.0% Y₂O₃ | | | |
| Formed) | | | | |
| S11 | 4.0% MgO | | | |
| (To be | 0.5% Y₂O₃ | | | |
| Formed) | | | | |
| S12 | 4.0% MgO | | | |
| (To be | 5.0% Y₂O₃ | | | |
| Formed) | | | | |
| S13 | 4.0% MgO | | | |
| (To be | 8.0% Y₂O₃ | | | |
| Formed) | | | | |

FIG. 12 includes plots of Vickers Hot Hardness for certain samples and comparative samples according to the hot hardness test. Notably, as illustrated, Sample S7 demonstrates the highest hot hardness compared to samples CS1 and CS3, with a Vickers Hot Hardness of approximately 31 GPa at room temperature, a Vickers Hot Hardness of approximately 23 GPa at 400° C., a Vickers Hot Hardness of approximately 22 GPa at 600° C., a Vickers Hot Hardness of approximately 18 GPa at 800° C., and a Vickers Hot Hardness of approximately 13.5 GPa at 1000° C. Sample S7 has a hot hardness approximately 3 GPa higher than Comparative Samples CS1 and CS3, an approximate increase of 20% in hot hardness. Samples S4 to S6 and S8 to S13 may have a hot hardness, creep, grinding performance, or a combination thereof similar to that of Sample S7.

One or more of Samples S4 to S13 may be distinct based upon hot hardness, creep, grinding performance or a combination thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

### Embodiment 1

An abrasive particle comprising:

a body having at least one microstructural characteristic including:
1) an average crystal size of not greater than 6 microns; or
2) a hardness of at least 20 GPa;

and wherein the body further comprises at least one deformation characteristic including:
1) a primary deformation amplitude of not greater than 30 percent
2) a primary deformation time of not greater than 280 minutes; or
3) a secondary deformation characteristic rate of not greater than 6×10⁻³ percent/minute.

### Embodiment 2

An abrasive particle comprising a body having an average crystal size of not greater than 6 microns and a primary deformation amplitude of not greater than 30 percent.

### Embodiment 3

An abrasive particle comprising a body having a hardness of at least 20 GPa and a primary deformation amplitude of not greater than 30 percent.

### Embodiment 4

An abrasive particle comprising shaped abrasive particle including a body having a primary deformation amplitude and time multiplier of not greater than 700 percent minutes.

### Embodiment 5

An abrasive particle comprising a body including a first dopant comprising magnesium and a second dopant comprising at least one element of the group consisting of yttrium, lanthanum, a rare-earth element, wherein the body comprises a greater content of the second dopant compared to a content of the first dopant, and a primary deformation amplitude of not greater than 9 percent.

### Embodiment 6

An abrasive particle comprising a body including a first dopant comprising magnesium and a grain boundary phase comprising at least one of yttrium, lanthanum, and a rare-earth element combined with aluminum and oxygen.

### Embodiment 7

The abrasive particle of any one of Embodiments 1, 2, 3, 5, and 6, wherein the body comprises:

at least one microstructural characteristic selected from the group consisting of:
1) an average crystal size of not greater than 6 microns; or
2) a hardness of at least 20 GPa;

and wherein the body further comprises at least one deformation characteristic selected from the group consisting of:
1) a primary deformation amplitude of not greater than 30 percent
2) a primary deformation time of not greater than 280 minutes; or
3) a secondary deformation characteristic rate of not greater than 6×10−3 percent/minute.

### Embodiment 8

The abrasive particle of any one of Embodiments 1, 2, 3, 5, and 6, wherein the body comprises:

microstructural characteristics including:
1) an average crystal size of not greater than 6 microns; and
2) a hardness of at least 20 GPa; and

wherein the body further comprises deformation characteristics including:
1) a primary deformation amplitude of not greater than 30 percent
2) a primary deformation time of not greater than 280 minutes; and
3) a secondary deformation characteristic rate of not greater than 6×10−3 percent/minute.

### Embodiment 9

The abrasive particle of any one of Embodiments 1, 2, 3, 5, and 6, wherein the abrasive particle is a shaped abrasive particle.

### Embodiment 10

The shaped abrasive particle of any one of Embodiments 4 and 9, wherein the shaped abrasive particle includes a body having a two-dimensional shape selected from the group consisting of polygons, ellipsoids, numerals, Greek alphabet letters, Latin alphabet letters, Russian alphabet characters, complex shapes, and a combination thereof.

### Embodiment 11

The shaped abrasive particle of any one of Embodiments 4 and 9, wherein the shaped abrasive particle includes a body having a two-dimensional polygonal shape selected from the group consisting of a triangle, a rectangle, a quadrilateral, a pentagon, a hexagon, a heptagon, an octagon, a nonagon, a decagon, and a combination thereof.

### Embodiment 12

The shaped abrasive particle of any one of Embodiments 4 and 9, wherein the shaped abrasive particle includes a body having a Shape Index of at least 0.01 and not greater than 0.49.

### Embodiment 13

The shaped abrasive particle of any one of Embodiments 4 and 9, wherein the shaped abrasive particle includes a body having a Shape Index of greater than 0.52 and not greater than 0.99.

### Embodiment 14

The shaped abrasive particle of any one of Embodiments 4 and 9, wherein the shaped abrasive particle includes a body having a perimeter defined by at least one linear section and at least one arcuate section.

### Embodiment 15

The shaped abrasive particle of any one of Embodiments 4 and 9, wherein the shaped abrasive particle includes a body having a central region and at least three arms extending from the central region.

### Embodiment 16

The shaped abrasive particle of any one of Embodiments 4 and 9, wherein the arms comprise tips including external corners defined by a joint between two linear sections and at least one arcuate portion extending between two external corners.

### Embodiment 17

The shaped abrasive particle of any one of Embodiments 4 and 9, wherein the shaped abrasive particle includes a two-dimensional shape having perimeter defined by at least three discrete linear portions and three discrete arcuate portions, wherein each of the three discrete linear portions are separated from each other by at least one of the discrete arcuate portions.

### Embodiment 18

The abrasive particle of any one of Embodiments 3, 4, 5, and 6, wherein the body comprises an average crystal size of not greater than 6 microns.

### Embodiment 19

The abrasive particle of any one of Embodiments 1, 2, and 18, wherein the body comprises an average crystal size of not greater than 5 microns or not greater than 4 microns or not greater than 3.5 microns or not greater than 3 microns or not greater than 2.5 microns or not greater than 2 microns or not greater than 1.5 microns or not greater than 1 micron or not greater than 0.8 microns or not greater than 0.6 microns.

### Embodiment 20

The abrasive particle of any one of Embodiments 1, 2, and 18, wherein the body comprises an average crystal size of at least 0.01 microns.

### Embodiment 21

The abrasive particle of any one of Embodiments 2, 4, 5, and 6, wherein the body comprises a hardness of at least 20 GPa.

### Embodiment 22

The abrasive particle of any one of Embodiments 1, 3, and 21, wherein the body comprises a hardness of at least 20.5 GPa or at least 21 GPa or at least 21.5 GPa or at least 22 GPa.

### Embodiment 23

The abrasive particle of any one of Embodiments 1, 3, and 21, wherein the body comprises a hardness of not greater than 40 GPa or not greater than 30 GPa or not greater than 28 GPa.

### Embodiment 24

The abrasive particle of any one of Embodiments 4, 5, and 6, wherein the body comprises a primary deformation amplitude of not greater than 30 percent.

### Embodiment 25

The abrasive particle of any one of Embodiments 1, 2, 3, and 24, wherein the body comprises a primary deformation amplitude of not greater than 25 percent or not greater than 20 percent or not greater than 18 percent or not greater than 16 percent or not greater than 14 percent or not greater than 13 percent or not greater than 12 percent or not greater than 11 percent or not greater than 10 percent or not greater than 9 percent or not greater than 8 percent or not greater than 7 percent or not greater than 6 percent or not greater than 5 percent.

### Embodiment 26

The abrasive particle of any one of Embodiments 1, 2, 3, and 24, wherein the body comprises a primary deformation amplitude of at least 0.01 percent or at least 0.1 percent.

### Embodiment 27

The abrasive particle of any one of Embodiments 2, 3, 4, 5, and 6, wherein the body comprises a primary deformation time of not greater than 280 minutes.

### Embodiment 28

The abrasive particle of any one of Embodiments 1 and 27, wherein the body comprises a primary deformation time of not greater than 250 minutes or not greater than 230 minutes or not greater than 200 minutes or not greater than 180 minutes or not greater than 160 minutes or not greater than 150 minutes.

### Embodiment 29

The abrasive particle of any one of Embodiments 1 and 27, wherein the body comprises a primary deformation time of at least 100 minutes or at least 110 minutes or at least 120 minutes or at least 130 minutes or at least 140 minutes.

### Embodiment 30

The abrasive particle of any one of Embodiments 1, 2, 3, 5, and 6, wherein the body comprises a primary deformation amplitude and time multiplier of not greater than 700 percent minutes.

### Embodiment 31

The abrasive particle of any one of Embodiments 4 and 30, wherein the body comprises a primary deformation amplitude and time multiplier of not greater than 690 percent minutesor not greater than 680 percent minutes or not greater than 670 percent minutes or not greater than 660 percent minutes or not greater than 650 percent minutes or not greater than 640 percent minutes or not greater than 630 percent minutes or not greater than 620 percent minutes or not greater than 610 percent minutes or not greater than 600 percent minutes or not greater than 590 percent minutes or not greater than 580 percent minutes or not greater than 570 percent minutes or even not greater than 560 percent minutes.

### Embodiment 32

The abrasive particle of any one of Embodiments 4 and 30, wherein the body comprises a primary deformation amplitude and time multiplier of at least 100 percent minutes or at least 150 percent minutes or at least 200 percent minutes.

### Embodiment 33

The abrasive particle of any one of Embodiments 2, 3, 4, 5, and 6, wherein the body comprises a secondary deformation characteristic rate of not greater than 6×10⁻³percent/minute.

### Embodiment 34

The abrasive particle of any one of Embodiments 1 and 33, wherein the body comprises a secondary deformation characteristic rate of not greater than 6×10⁻³ percent/minute or not greater than 4×10⁻³ percent/minute or not greater than 2×10⁻³ percent/minute or not greater than 1×10⁻³ percent/minute or not greater than 8×10⁻⁴ percent/minute or not greater than 5×10⁻⁴ percent/minute or not greater than 1×10⁻⁴ percent/minute or not greater than 5×10⁻⁵ percent/minute or not greater than 1×10⁻⁵ percent/minute or not greater than 5×10⁻⁶ percent/minute or not greater than 1×10⁻⁶ percent/minute or not greater than 5×10⁻⁷ percent/minute or not greater than 1×10⁻⁷ percent/minute or not greater than 5×10⁻⁸ percent/minute.

### Embodiment 35

The abrasive particle of any one of Embodiments 1 and 33, wherein the body comprises a secondary deformation characteristic rate of at least 1×10⁻¹² percent/minute or at least 1×10⁻¹° percent/minute.

### Embodiment 36

The abrasive particle of any one of Embodiments 1, 2, 3, 4, 5, and 6, wherein the body comprises a density of at least 95% theoretical density or at least 96% theoretical density or at least 97% theoretical density or at least 98% theoretical density or at least 99% theoretical density.

### Embodiment 37

The abrasive particle of any one of Embodiments 1, 2, 3, 4, 5, and 6, wherein the body comprises alumina.

### Embodiment 38

The abrasive particle of any one of Embodiments 1, 2, 3, 4, 5, and 6, wherein the body includes a majority content of alumina, wherein the body includes at least 80% alumina or at least 90% alumina or at least 91% alumina or at least 92% alumina or at least 93% alumina or at least 94% alumina or at least 95% alumina or at least 96% alumina or at least 97% alumina.

### Embodiment 39

The abrasive particle of any one of Embodiments 1, 2, 3, and 4, wherein the body comprises a first dopant comprising magnesium.

### Embodiment 40

The abrasive particle of any one of Embodiments 5, 6, and 39, wherein the first dopant comprises a majority content of magnesium and oxygen.

### Embodiment 41

The abrasive particle of any one of Embodiments 5, 6, and 39, wherein the first dopant consists essentially of magnesium and oxygen.

### Embodiment 42

The abrasive particle of any one of Embodiments 5, 6, and 39, wherein the body comprises at least 0.1 wt % of the first dopant for the total weight of the body or at least 0.15 wt % or at least 0.2 wt % or at least 0.3 wt % or at least 0.4 wt % or at least 0.5 wt % or at least 0.6 wt % or at least 0.7 wt % or at least 0.8 wt % or at least 0.9 wt %.

### Embodiment 43

The abrasive particle of any one of Embodiments 5, 6, and 39, wherein the body comprises not greater than 4.5 wt % of the first dopant for the total weight of the body or not greater than 4 wt % or not greater than 3 wt % or not greater than 2.5 wt % or not greater than 2.2 wt % or not greater than 2 wt % or not greater than 1.9 wt % or not greater than 1.8 wt % or not greater than 1.7 wt % or not greater than 1.6 wt % or not greater than 1.5 wt % or not greater than 1.4 wt % or not greater than 1.3 wt % or not greater than 1.2 wt %.

### Embodiment 44

The abrasive particle of any one of Embodiments 1, 2, 3, and 4, wherein the body comprises a first dopant and a second dopant different than the first dopant.

### Embodiment 45

The abrasive particle of any one of Embodiments 5, 6, and 44, wherein the second dopant comprises at least one element from the group consisting of yttrium, lanthanum, a rare-earth element, and a combination thereof.

### Embodiment 46

The abrasive particle of any one of Embodiments 5, 6, and 44, wherein the first dopant is present in a first grain boundary phase and the second dopant is present in a second grain boundary phase, and wherein the first and second grain boundary phases are substantially homogeneous throughout the body.

### Embodiment 47

The abrasive particle of any one of Embodiments 5, 6, and 44, wherein the first and second dopants are substantially homogeneously dispersed throughout the entire volume of the body.

### Embodiment 48

The abrasive particle of any one of Embodiments 5, 6, and 44, wherein at least one of the first and second dopants are preferentially distributed in a higher concentration near the exterior surfaces of the body compared to the interior region surrounding a volumetric midpoint of the body.

### Embodiment 49

The abrasive particle of any one of Embodiments 5, 6, and 44, wherein the second dopant comprises a majority content of yttrium and oxygen.

### Embodiment 50

The abrasive particle of any one of Embodiments 5, 6, and 44, wherein the second dopant consists essentially of yttrium and oxygen.

### Embodiment 51

The abrasive particle of any one of Embodiments 5, 6, and 44, wherein the body comprises at least 0.1 wt % of the second dopant for the total weight of the body or at least 0.2 wt % or at least 0.4 wt % or at least 0.6 wt % or at least 0.8 wt % or at least 1 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or at least 2 wt %.

### Embodiment 52

The abrasive particle of any one of Embodiments 5, 6, and 44, wherein the body comprises not greater than 10 wt % of the second dopant for the total weight of the body or not greater than 9 wt % or not greater than 8 wt % or not greater than 7 wt % or not greater than 6 wt % or not greater than 5 wt % or not greater than 4 wt % or not greater than 3.5 wt % or not greater than 3.2 wt % or not greater than 3 wt % or not greater than 2.9 wt % or not greater than 2.8 wt % or not greater than 2.7 wt % or not greater than 2.6 wt % or not greater than 2.5 wt % or not greater than 2.4 wt % or not greater than 2.3 wt % or not greater than 2.2 wt % or not greater than 2.1 wt %.

### Embodiment 53

The abrasive particle of any one of Embodiments 5, 6, and 44, wherein the body comprises a dopant ratio value (D1/D2) of at least 1, wherein D1 represents the weight percent of the first dopant in the body and D2 represent the weight percent of the second dopant in the body, wherein the dopant ratio value is greater than 1 or at least 1.1 or at least 1.2 or at least 1.3 or at least 1.4 or at least 1.5 or at least 1.6 or at least 1.7 or at least 1.8 or at least 1.9 or at least 2.

### Embodiment 54

The abrasive particle of any one of Embodiments 5, 6, and 44, wherein the body comprises a dopant ratio value (D1/D2) of not greater than 10, wherein D1 represents the weight percent of the first dopant in the body and D2 represent the weight percent of the second dopant in the body, wherein the dopant ratio value is not greater than 9 or not greater than 8 or not greater than 7 or not greater than 6 or not greater than 5 or not greater than 4 or not greater than 3.5 or not greater than 3 or not greater than 2.8 or not greater than 2.5.

### Embodiment 55

The abrasive particle of any one of Embodiments 5, 6, and 44, wherein the body comprises a dopant ratio value (D2/D1) of at least 1, wherein D1 represents the weight percent of the first dopant in the body and D2 represent the weight percent of the second dopant in the body, wherein the dopant ratio value is greater than 1 or at least 1.1 or at least 1.2 or at least 1.3 or at least 1.4 or at least 1.5 or at least 1.6 or at least 1.7 or at least 1.8 or at least 1.9 or at least 2.

### Embodiment 56

The abrasive particle of any one of Embodiments 5, 6, and 42, wherein the body comprises a dopant ratio value (D2/D1) of not greater than 10, wherein D1 represents the weight percent of the first dopant in the body and D2 represent the weight percent of the second dopant in the body, wherein the dopant ratio value is not greater than 9 or not greater than 8 or not greater than 7 or not greater than 6 or not greater than 5 or not greater than 4 or not greater than 3.5 or not greater than 3 or not greater than 2.8 or not greater than 2.5.

### Embodiment 57

The abrasive particle of any one of Embodiments 1, 2, 3, 4, 5, and 6, wherein the body is essentially free of zirconium, cobalt, iron, calcium, carbides, nitrides, silicon, lithium, sodium, potassium, strontium, titanium, vanadium, chromium, manganese, nickel, copper, zinc, niobium, molybdenum, ruthenium, palladium, hafnium, tantalum, lanthanum, cerium, neodymium, scandium, zinc, and a combination thereof.

### Embodiment 58

The abrasive particle of any one of Embodiments 1, 2, 3, 4, 5, and 6, wherein the body is essentially free of a rare earth metal selected from praseodymium, samarium, ytterbium, neodymium, lanthanum, gadolinium, cerium, dysprosium, and erbium.

### Embodiment 59

The abrasive particle of any one of Embodiments 1, 2, 3, 4, 5, and 6, wherein the body consists essentially of alpha alumina, magnesium-containing oxides, and yttrium-containing oxides, wherein the content of alpha alumina is greater than the magnesium-containing oxides, and the content of the magnesium-containing oxides is greater than the content of yttrium-containing oxides.

### Embodiment 60

The abrasive particle of any one of Embodiments 1, 2, 3, 4, 5, and 6, wherein the body further comprises zirconium, lanthanum, strontium, lutetium, neodymium, and a combination thereof.

### Embodiment 61

The abrasive particle of any one of Embodiments 1, 2, 3, 4, and 5, wherein the body includes a grain boundary phase comprising yttrium, aluminum, and oxygen.

### Embodiment 62

The abrasive particle of any one of Embodiments 6 and 61, wherein the grain boundary phase is an oxide compound including yttrium and aluminum.

### Embodiment 63

The abrasive particle of any one of Embodiments 6 and 61, wherein the grain boundary phase is a yttrium aluminate compound.

### Embodiment 64

The abrasive particle of any one of Embodiments 6 and 61, wherein the grain boundary phase comprises a polycrystalline material bonded to the surrounding grains.

### Embodiment 65

The abrasive particle of any one of Embodiments 1, 2, 3, 4, 5, and 6, further comprising a fixed abrasive article including the abrasive particle.

### Embodiment 66

The abrasive particle of Embodiment 65, wherein the fixed abrasive article is selected from the group consisting of a coated abrasive, a bonded abrasive, a non-woven abrasive, and a combination thereof.

### Embodiment 67

The abrasive particle of any one of the preceding Embodiments, wherein the abrasive particle has a 1000° C. Vickers Hot Hardness of at least 12.0 GPa, at least 12.2 GPa, at least 12.5 GPa, at least 12.7 GPa, at least 13.0 GPa, at least 13.3 GPa, or at least 13.5 GPa.

### Embodiment 68

The abrasive particle of any one of the preceding Embodiments, wherein the abrasive particle has a 1000° C. Vickers Hot Hardness of no greater than 20 GPa, no greater than 18 GPa, or no greater than 15 GPa.

### Embodiment 69

The abrasive particle of any one of the preceding Embodiments, wherein the abrasive particle has a 800° C. Vickers Hot Hardness of at least 14.5 GPa, at least 15.0 GPa, at least 15.5 GPa, at least 16.0 GPa, at least 16.5 GPa, at least 17.0 GPa, at least 17.5 GPa, or at least 18.0 GPa.

### Embodiment 70

The abrasive particle of any one of the preceding Embodiments, wherein the abrasive particle has a 800° C. Vickers Hot Hardness of no greater than 25 GPa, no greater than 23 GPa, no greater than 21 GPa, or no greater than 20 GPa.

### Embodiment 71

The abrasive particle of any one of the preceding Embodiments, wherein the abrasive particle has a 600° C. Vickers Hot Hardness of at least 19 GPa, at least 19.5 GPa, at least 20.0 GPa, at least 20.5 GPa, at least 21.0 GPa, at least 21.5 GPa, or at least 22.0 GPa.

### Embodiment 72

The abrasive particle of any one of the preceding Embodiments, wherein the abrasive particle has a 600° C. Vickers Hot hardness of no greater than 27.0 GPa, no greater than 25.0 GPa, or no greater than 23.0 GPa.

### Embodiment 73

The abrasive particle of any one of the preceding Embodiments, wherein the abrasive particle has a 400° C. Vickers Hot Hardness of at least 19.0 GPa, at least 19.5 GPa, at least 20.0 GPa, at least 20.5 GPa, at least 21.0 GPa, at least 21.5 GPa, at least 22.0 GPa, at least 22.5 GPa, or at least 23.0 GPa.

### Embodiment 74

The abrasive particle of any one of the preceding Embodiments, wherein the abrasive particle has a 400° C. Vickers Hot Hardness of no greater than 35.0 GPa, no greater than 31.0 GPa, no greater than 27.0 GPa, or no greater than 24.0 GPa.

### Embodiment 75

A method of making an abrasive particle including forming a mixture including an alpha alumina precursor material a first dopant comprising magnesium and a second dopant comprising yttrium, wherein the content of the second dopant is greater than the first dopant, and sintering the mixture to form an abrasive particle.

### Embodiment 76

The method of Embodiment 75, wherein the abrasive particle comprises an abrasive particle in accordance with any one of Embodiments 1-74.

### Embodiment 77

The method of any one of Embodiments 75 and 76, wherein the method further comprises attaching the abrasive particle to an abrasive article.

### Embodiment 78

The method of any one of Embodiments 75-77, further comprising drying mixture prior to sintering the mixture.

### Embodiment 79

The method of any one of Embodiments 75-78, wherein the mixture is introduced to a mold cavity for shaping.

### Embodiment 80

The method of Embodiment 79, wherein the mixture undergoes drying while in the mold cavity.

### Embodiment 81

The method of any one of Embodiments 79 and 80, wherein a mold release agent is applied to the mixture while the mixture is in the mold cavity.

### Embodiment 82

The method of any one of Embodiments 79-81, wherein the mixture is released from the mold cavity to form a precursor shaped abrasive particle.

### Embodiment 83

The method of any one of Embodiments 75-82, wherein at least one of the first and second dopants is applied by spraying, dipping, depositing, impregnating, transferring, punching, cutting, pressing, crushing, or any combination thereof.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. An abrasive particle comprising:
a body having at least one microstructural characteristic including:
1) an average crystal size of not greater than 6 microns; or
2) a hardness of at least 20 GPa;
and wherein the body further comprises at least one deformation characteristic including:
3) a primary deformation amplitude of not greater than 30 percent
4) a primary deformation time of not greater than 280 minutes; or
5) a secondary deformation characteristic rate of not greater than 6×10⁻³ percent/minute.

2. The abrasive particle of claim 1, wherein the abrasive particle is a shaped abrasive particle.

3. The abrasive particle of claim 1, wherein the body comprises a first dopant and a second dopant different than the first dopant.

4. The abrasive particle of claim 3, wherein the first dopant comprises magnesium and the second dopant comprises at least one element from the group consisting of yttrium, lanthanum, a rare-earth element, and a combination thereof.

5. The abrasive particle of claim 3, wherein the first dopant is present in a first grain boundary phase and the second dopant is present in a second grain boundary phase, and wherein the first and second grain boundary phases are substantially homogeneous throughout the body.

6. The abrasive particle of claim 3, wherein at least one of the first and second dopants are preferentially distributed in a higher concentration near the exterior surfaces of the body compared to the interior region surrounding a volumetric midpoint of the body.

7. The abrasive particle of claim 3, wherein the body comprises a dopant ratio value (D1/D2) of at least 1, wherein D1 represents the weight percent of the first dopant in the body and D2 represent the weight percent of the second dopant in the body.

8. The abrasive particle of claim 3, wherein the body comprises a dopant ratio value (D1/D2) of at least 1, wherein D1 represents the weight percent of the first dopant in the body and D2 represent the weight percent of the second dopant in the body.

9. The abrasive particle of claim 3, wherein the body is essentially free of a rare earth metal selected from praseodymium, samarium, ytterbium, neodymium, lanthanum, gadolinium, cerium, dysprosium, and erbium.

10. The abrasive particle of claim 1, further comprising a fixed abrasive article including the abrasive particle, wherein the fixed abrasive article is selected from the group consisting of a coated abrasive, a bonded abrasive, a non-woven abrasive, and a combination thereof.

11. An abrasive particle comprising a body having an average crystal size of not greater than 6 microns and a primary deformation amplitude of not greater than 30 percent.

12. The abrasive particle of claim 11, wherein the body comprises a hardness of at least 20 GPa.

13. The abrasive particle of claim 11, wherein the abrasive particle is a shaped abrasive particle.

14. The shaped abrasive particle of claim 13, wherein the shaped abrasive particle includes a central region and at least three arms extending from the central region.

15. The abrasive particle of claim 11, wherein the body comprises a first dopant and a second dopant different than the first dopant.

16. The abrasive particle of claim 15, wherein the first dopant is present in a first grain boundary phase and the second dopant is present in a second grain boundary phase, and wherein the first and second grain boundary phases are substantially homogeneous throughout the body.

17. The abrasive particle of claim 15, wherein at least one of the first and second dopants are preferentially distributed in a higher concentration near the exterior surfaces of the body compared to the interior region surrounding a volumetric midpoint of the body.

18. The abrasive particle of claim 15, wherein the body comprises a dopant ratio value (D1/D2) of at least 1, wherein D1 represents the weight percent of the first dopant in the body and D2 represent the weight percent of the second dopant in the body.

19. The abrasive particle of claim 15, further comprising a fixed abrasive article including the abrasive particle, wherein the fixed abrasive article is selected from the group consisting of a coated abrasive, a bonded abrasive, a non-woven abrasive, and a combination thereof.

20. A method of making an abrasive particle including forming a mixture including an alpha alumina precursor material a first dopant comprising magnesium and a second dopant comprising yttrium, wherein the content of the second dopant is greater than the first dopant, and sintering the mixture to form an abrasive particle.
